(19) United States
(12) Patent Application Publication
(10) Pub. No.: US 2015/0316083 A1
(43) Pub. Date: Nov. 5, 2015

(54) God's Presence

(71) Applicant: Svetozar B. Petrovich, Chicago, IL (US)

(72) Inventor: Svetozar B. Petrovich, Chicago, IL (US)

(21) Appl. No.: 13/999,105

(22) Filed: Jan. 13, 2014

Related U.S. Application Data
(63) Continuation-in-part of application No. 13/999,086, filed on Jan. 10, 2014.
Application No. 13/999,086 is a continuation-in-part of application No. PCT/US2012/000572, filed on Dec. 6, 2012.
Application No. PCT/US2012/000572 is a continuation-in-part of application No. PCT/US2012/000319, filed on Jul. 11, 2012.
Application No. PCT/US2012/000319 is a continuation-in-part of application No. 13/506,098, filed on Mar. 27, 2012, now abandoned.
Application No. 13/506,098 is a continuation-in-part of application No. 13/136,140, filed on Jul. 25, 2011, now abandoned.
Application No. 13/136,140 is a continuation-in-part of application No. 13/068,587, filed on May 16, 2011, now abandoned.
Application No. 13/068,587 is a continuation-in-part of application No. 13/135,617, filed on Jul. 11, 2011, now abandoned.
Application No. 13/999,086 is a continuation-in-part of application No. PCT/US2012/000572, filed on Dec. 6, 2012.
Application No. PCT/US2012/000572 is a continuation-in-part of application No. PCT/US2012/000319, filed on Jul. 11, 2012.
Application No. PCT/US2012/000319 is a continuation-in-part of application No. 13/506,098, filed on Mar. 27, 2012, now abandoned.
Application No. 13/506,098 is a continuation-in-part of application No. 13/136,140, filed on Jul. 25, 2011, now abandoned.
Application No. 13/136,140 is a continuation-in-part of application No. 13/135,617, filed on Jul. 11, 2011, now abandoned.
Application No. 13/135,617 is a continuation-in-part of application No. 13/068,587, filed on May 16, 2011, now abandoned.
Application No. PCT/US2012/000572 is a continuation-in-part of application No. PCT/US2012/000319, filed on Jul. 11, 2012.
Application No. PCT/US2012/000319 is a continuation-in-part of application No. 13/506,098, filed on Mar. 27, 2012, now abandoned.
Application No. 13/506,098 is a continuation-in-part of application No. 13/136,140, filed on Jul. 25, 2011, now abandoned.
Application No. 13/136,140 is a continuation-in-part of application No. 13/068,587, filed on May 16, 2011, now abandoned.
Application No. 13/068,587 is a continuation-in-part of application No. 13/135,617, filed on Jul. 11, 2011, now abandoned.
Application No. PCT/US2012/000319 is a continuation-in-part of application No. 13/506,098, filed on Mar. 27, 2012, now abandoned.
Application No. 13/506,098 is a continuation-in-part of application No. 13/136,140, filed on Jul. 25, 2011, now abandoned.
Application No. 13/136,140 is a continuation-in-part of application No. 13/135,617, filed on Jul. 11, 2011, now abandoned.
Application No. 13/135,617 is a continuation-in-part of application No. 13/068,587, filed on May 16, 2011, now abandoned.
Application No. 13/506,098 is a continuation-in-part of application No. 13/136,140, filed on Jul. 25, 2011, now abandoned.
Application No. 13/136,140 is a continuation-in-part of application No. 13/135,617, filed on Jul. 11, 2011, now abandoned.
Application No. 13/135,617 is a continuation-in-part of application No. 13/068,587, filed on May 16, 2011, now abandoned.
Application No. 13/068,587 is a continuation-in-part of application No. 12/153,036, filed on May 13, 2008, now abandoned.
Application No. 13/136,140 is a continuation-in-part of application No. 13/135,617, filed on Jul. 11, 2011, now abandoned.
Application No. 13/135,617 is a continuation-in-part of application No. 13/068,587, filed on May 16, 2011, now abandoned.
Application No. 13/068,587 is a continuation-in-part of application No. 12/320,441, filed on Jan. 26, 2009, now abandoned.
Application No. 12/320,441 is a continuation-in-part of application No. 12/153,036, filed on May 13, 2008, now abandoned.
Application No. 12/153,036 is a continuation-in-part of application No. PCT/US2010/001379, filed on May 10, 2010.
Application No. PCT/US2010/001379 is a continuation-in-part of application No. PCT/US2010/000188, filed on Jan. 25, 2010.
Application No. PCT/US2010/000188 is a continuation-in-part of application No. PCT/US2010/000187, filed on Jan. 25, 2010.
Application No. 13/135,617 is a continuation-in-part of application No. 13/068,587, filed on May 16, 2011, now abandoned.
Application No. 13/068,587 is a continuation-in-part of application No. 12/320,441, filed on Jan. 26, 2009, now abandoned.
Application No. 12/320,441 is a continuation-in-part of application No. PCT/US2010/000188, filed on Jan. 25, 2010.
Application No. PCT/US2010/000188 is a continuation-in-part of application No. PCT/US2010/001379, filed on May 10, 2010.
Application No. PCT/US2010/001379 is a continuation-in-part of application No. 12/153,036, filed on May 13, 2008, now abandoned.
Application No. 12/153,036 is a continuation-in-part of application No. PCT/US2010/000187, filed on Jan. 25, 2010.
Application No. 13/068,587 is a continuation-in-part of application No. 12/658,099, filed on Feb. 1, 2010, now abandoned.
Application No. 12/658,099 is a continuation-in-part of application No. 12/453,444, filed on May 12, 2009, now abandoned.
Application No. 12/453,444 is a continuation-in-part of application No. 12/320,441, filed on Jan. 26, 2009, now abandoned.
Application No. 12/320,441 is a continuation-in-part of application No. 12/153,036, filed on May 13, 2008, now abandoned.
Application No. 12/153,036 is a continuation-in-part of application No. PCT/US2010/001379, filed on May 10, 2010.
Application No. PCT/US2010/001379 is a continuation-in-part of application No. PCT/US2010/000188, filed on Jan. 25, 2010.
Application No. PCT/US2010/000188 is a continuation-in-part of application No. PCT/US2010/000187, filed on Jan. 25, 2010.
Application No. PCT/US2010/001379 is a continuation-in-part of application No. 12/658,099, filed on Feb. 1, 2010, now abandoned.
Application No. 12/658,099 is a continuation-in-part of application No. 12/453,444, filed on May 12, 2009, now abandoned.
Application No. 12/453,444 is a continuation-in-part of application No. 12/320,441, filed on Jan. 26, 2009, now abandoned.
Application No. 12/320,441 is a continuation-in-part of application No. PCT/US2010/000188, filed on Jan. 25, 2010.
Application No. PCT/US2010/000188 is a continuation-in-part of application No. PCT/US2010/000187, filed on Jan. 25, 2010.
Application No. PCT/US2010/000187 is a continuation-in-part of application No. 12/153,036, filed on May 13, 2008, now abandoned.
Application No. 12/658,099 is a continuation-in-part of application No. 12/453,444, filed on May 12, 2009, now abandoned.
Application No. 12/453,444 is a continuation-in-part of application No. 12/382,448, filed on Mar. 17, 2009, now abandoned.
Application No. 12/382,448 is a continuation-in-part of application No. 12/320,441, filed on Jan. 26, 2009, now abandoned.
Application No. 12/320,441 is a continuation-in-part of application No. 12/320,440, filed on Jan. 26, 2009, now abandoned.
Application No. 12/320,440 is a continuation-in-part of application No. 12/153,036, filed on May 13, 2008, now abandoned.
Application No. 12/153,036 is a continuation-in-part of application No. 11/724,752, filed on Mar. 15, 2007, now abandoned.
Application No. 11/724,752 is a continuation-in-part of application No. PCT/US2010/000188, filed on Jan. 25, 2010.
Application No. PCT/US2010/000188 is a continuation-in-part of application No. PCT/US2010/000187, filed on Jan. 25, 2010.
Application No. PCT/US2010/000188 is a continuation-in-part of application No. 12/453,444, filed on May 12, 2009, now abandoned.
Application No. 12/453,444 is a continuation-in-part of application No. 12/382,448, filed on Mar. 17, 2009, now abandoned.
Application No. 12/382,448 is a continuation-in-part of application No. 12/320,441, filed on Jan. 26, 2009, now abandoned.
Application No. 12/320,441 is a continuation-in-part of application No. 12/320,440, filed on Jan. 26, 2009, now abandoned.
Application No. 12/320,440 is a continuation-in-part of application No. 12/153,036, filed on May 13, 2008, now abandoned.
Application No. 12/153,036 is a continuation-in-part of application No. 11/724,752, filed on Mar. 15, 2007, now abandoned.
Application No. PCT/US2010/000187 is a continuation-in-part of application No. 12/453,444, filed on May 12, 2009, now abandoned.
Application No. 12/453,444 is a continuation-in-part of application No. 12/382,448, filed on Mar. 17, 2009, now abandoned.
Application No. 12/382,448 is a continuation-in-part of application No. 12/320,441, filed on Jan. 26, 2009, now abandoned.
Application No. 12/320,441 is a continuation-in-part of application No. 12/320,440, filed on Jan. 26, 2009, now abandoned.
Application No. 12/320,440 is a continuation-in-part of application No. 12/153,036, filed on May 13, 2008, now abandoned.
Application No. 12/153,036 is a continuation-in-part of application No. 11/724,752, filed on Mar. 15, 2007, now abandoned.
Application No. 12/453,444 is a continuation-in-part of application No. 12/382,448, filed on Mar. 17, 2009, now abandoned.
Application No. 12/382,448 is a continuation-in-part of application No. 12/320,441, filed on Jan. 26, 2009, now abandoned.
Application No. 12/320,441 is a continuation-in-part of application No. 12/320,440, filed on Jan. 26, 2009, now abandoned.
Application No. 12/320,440 is a continuation-in-part of application No. 12/153,036, filed on May 13, 2008, now abandoned.
Application No. 12/153,036 is a continuation-in-part of application No. 11/724,752, filed on Mar. 15, 2007, now abandoned.
Application No. 12/382,448 is a continuation-in-part of application No. 12/320,441, filed on Jan. 26, 2009, now abandoned.
Application No. 12/320,441 is a continuation-in-part of application No. 12/320,440, filed on Jan. 26, 2009, now abandoned.
Application No. 12/320,440 is a continuation-in-part of application No. 12/153,036, filed on May 13, 2008, now abandoned.
Application No. 12/153,036 is a continuation-in-part of application No. 11/809,132, filed on May 31, 2007, now abandoned.
Application No. 11/809,132 is a continuation-in-part of application No. 11/724,752, filed on Mar. 15, 2007, now abandoned.
Application No. 12/320,441 is a continuation-in-part of application No. 12/153,036, filed on May 13, 2008, now abandoned.
Application No. 12/153,036 is a continuation-in-part of application No. 11/724,752, filed on Mar. 15, 2007, now abandoned.
Application No. 11/724,752 is a continuation-in-part of application No. 11/807,748, filed on May 30, 2007, now abandoned.
Application No. 11/807,748 is a continuation-in-part of application No. 11/809,132, filed on May 31, 2007, now abandoned.
Application No. 12/320,440 is a continuation-in-part of application No. 12/153,036, filed on May 13, 2008, now abandoned.
Application No. 12/153,036 is a continuation-in-part of application No. 11/809,132, filed on May 31, 2007, now abandoned.
Application No. 11/809,132 is a continuation-in-part of application No. 11/807,748, filed on May 30, 2007, now abandoned.
Application No. 11/807,748 is a continuation-in-part of application No. 11/724,752, filed on Mar. 15, 2007, now abandoned.
Application No. 12/153,036 is a continuation-in-part of application No. 11/809,132, filed on May 31, 2007, now abandoned.
Application No. 11/809,132 is a continuation-in-part of application No. 11/807,748, filed on May 30, 2007, now abandoned.
Application No. 11/807,748 is a continuation-in-part of application No. 11/788,172, filed on Jun. 4, 2007, now abandoned.
Application No. 11/788,172 is a continuation-in-part of application No. 11/724,752, filed on Mar. 15, 2007, now abandoned.
Application No. 11/809,132 is a continuation-in-part of application No. 11/807,748, filed on May 30, 2007, now abandoned.
Application No. 11/807,748 is a continuation-in-part of application No. 11/724,752, filed on Mar. 15, 2007, now abandoned.
Application No. 11/724,752 is a continuation-in-part of application No. 11/504,304, filed on Aug. 14, 2006, now abandoned.
Application No. 11/807,748 is a continuation-in-part of application No. 11/724,752, filed on Mar. 15, 2007, now abandoned.
Application No. 11/724,752 is a continuation-in-part of application No. 11/504,304, filed on Aug. 14, 2006, now abandoned.
Application No. 11/504,304 is a continuation-in-part of application No. 11/385,078, filed on Mar. 20, 2006, now abandoned.
Application No. 11/788,172 is a continuation-in-part of application No. 11/724,752, filed on Mar. 15, 2007, now abandoned.
Application No. 11/724,752 is a continuation-in-part of application No. 11/504,304, filed on Aug. 14, 2006, now abandoned.
Application No. 11/504,304 is a continuation-in-part of application No. 11/385,078, filed on Mar. 20, 2006, now abandoned.
Application No. 11/385,078 is a continuation-in-part of application No. 11/504,304, filed on Aug. 14, 2006, now abandoned.
Application No. 11/504,304 is a continuation-in-part of application No. 11/418,157, filed on May 3, 2006, now abandoned.
Application No. 11/418,157 is a continuation-in-part of application No. 11/385,078, filed on Mar. 20, 2006, now abandoned.
Application No. 11/504,304 is a continuation-in-part of application No. 11/418,157, filed on May 3, 2006, now abandoned.
Application No. 11/418,157 is a continuation-in-part of application No. 11/385,078, filed on Mar. 20, 2006, now abandoned.
Application No. 11/385,078 is a continuation-in-part of application No. 11/342,006, filed on Jan. 30, 2006, now abandoned.
Application No. 11/418,157 is a continuation-in-part of application No. 11/385,078, filed on Mar. 20, 2006, now abandoned.
Application No. 11/385,078 is a continuation-in-part of application No. 11/342,006, filed on Jan. 30, 2006, now abandoned.
Application No. 11/342,006 is a continuation-in-part of application No. 11/233,546, filed on Sep. 23, 2005, now abandoned.
Application No. 11/385,078 is a continuation-in-part of application No. 11/342,006, filed on Jan. 30, 2006, now abandoned.
Application No. 11/342,006 is a continuation-in-part of application No. 11/233,546, filed on Sep. 23, 2005, now abandoned.
Application No. 11/233,546 is a continuation-in-part of application No. 11/212,943, filed on Aug. 25, 2005, now abandoned.
Application No. 11/342,006 is a continuation-in-part of application No. 11/233,546, filed on Sep. 23, 2005, now abandoned.
Application No. 11/233,546 is a continuation-in-part of application No. 11/212,943, filed on Aug. 25, 2005, now abandoned.
Application No. 11/233,546 is a continuation-in-part of application No. 11/212,943, filed on Aug. 25, 2005, now abandoned.
Application No. 11/212,943 is a continuation-in-part of application No. 11/188,339, filed on Jul. 25, 2005, now abandoned.
Application No. 11/188,339 is a continuation-in-part of application No. 10/869,752, filed on Jun. 16, 2004, now abandoned.
Application No. 11/212,943 is a continuation-in-part of application No. 11/188,339, filed on Jul. 25, 2005, now abandoned.
Application No. 11/188,339 is a continuation-in-part of application No. 10/869,752, filed on Jun. 16, 2004, now abandoned.
Application No. 10/869,752 is a continuation-in-part of application No. 10/840,152, filed on May 5, 2004, now abandoned.
Application No. 11/188,339 is a continuation-in-part of application No. 11/028,982, filed on Jan. 3, 2005, now abandoned.
Application No. 11/028,982 is a continuation-in-part of application No. 10/869,752, filed on Jun. 16, 2004, now abandoned.
Application No. 10/869,752 is a continuation-in-part of application No. 10/840,152, filed on May 5, 2004, now abandoned.
Application No. 11/028,982 is a continuation-in-part of application No. 10/869,752, filed on Jun. 16, 2004, now abandoned.
Application No. 10/869,752 is a continuation-in-part of application No. 10/840,152, filed on May 5, 2004, now abandoned.
Application No. 10/840,152 is a continuation-in-part of application No. 10/742,485, filed on Dec. 19, 2003, now abandoned.
Application No. 10/869,752 is a continuation-in-part of application No. 10/840,152, filed on May 5, 2004, now abandoned.
Application No. 10/840,152 is a continuation-in-part of application No. 10/742,485, filed on Dec. 19, 2003, now abandoned.
Application No. 10/742,485 is a continuation-in-part of application No. 10/156,192, filed on May 28, 2002, now abandoned.
Application No. 10/840,152 is a continuation-in-part of application No. 10/742,485, filed on Dec. 19, 2003, now abandoned.
Application No. 10/742,485 is a continuation-in-part of application No. 10/156,192, filed on May 28, 2002, now abandoned.
Application No. 10/156,192 is a continuation-in-part of application No. 10/190,993, filed on Jul. 8, 2002, now abandoned.
Application No. 10/742,485 is a continuation-in-part of application No. 10/156,192, filed on May 28, 2002, now abandoned.
Application No. 10/156,192 is a continuation-in-part of application No. 10/190,993, filed on Jul. 8, 2002, now abandoned.
Application No. 10/190,993 is a continuation-in-part of application No. 10/156,192, filed on May 28, 2002, now abandoned.
Application No. 10/156,192 is a continuation-in-part of application No. 10/073,914, filed on Feb. 14, 2002, now abandoned.
Application No. 10/073,914 is a continuation-in-part of application No. 09/850,927, filed on May 8, 2001, now abandoned.
Application No. 10/156,192 is a continuation-in-part of application No. 10/074,966, filed on Feb. 13, 2002, now abandoned.
Application No. 10/074,966 is a continuation-in-part of application No. 09/850,927, filed on May 8, 2001, now abandoned.
Application No. 10/074,966 is a continuation-in-part of application No. 09/850,927, filed on May 8, 2001, now abandoned.
Application No. 10/073,914 is a continuation-in-part of application No. 09/850,927, filed on May 8, 2001, now abandoned.
Application No. 09/850,927 is a continuation-in-part of application No. 09/518,884, filed on Mar. 6, 2000, now abandoned.
Application No. 09/518,884 is a continuation-in-part of application No. 09/376,957, filed on Aug. 18, 1999, now abandoned.
Application No. 09/376,957 is a continuation-in-part of application No. 09/376,957, filed on Aug. 18, 1999, now abandoned.
Application No. 09/376,957 is a continuation-in-part of application No. 08/950,898, filed on Oct. 15, 1997, now Pat. No. 5,941,273.
(60) Provisional application No. 60/231,514, filed on Sep. 9, 2000.
(60) Provisional application No. 60/226,750, filed on Aug. 21, 2000.
(60) Provisional application No. 60/220,358, filed on Jul. 24, 2000.
(60) Provisional application No. 60/123,504, filed on Mar. 9, 1999.
(60) Provisional application No. 60/123,207, filed on Mar. 8, 1999.
(60) Provisional application No. 60/123,153, filed on Mar. 6, 1999.
(60) Provisional application No. 60/123,504, filed on Mar. 9, 1999.
(60) Provisional application No. 60/123,207, filed on Mar. 8, 1999.
(60) Provisional application No. 60/123,153, filed on Mar. 6, 1999.

(51) Int. Cl. F15D 1/00

(52) U.S. Cl. CPC F15D 1/00

(57) ABSTRACT

A mass energy balancing of balancing everything in bounding sources and sinks of mass and energy is paths-of-passage (PP) of quantum in and from sources into and in sinks of mass energy having quantal mass and quantum PP lengths, spawning the PP lengths least sum (PPLLS) that is cosmological nullity. A mass energy highest conserving (MEHC) of flowing fluids affirms all of cosmological nullities of the nullity and ultimate longevities of conforming quanta and balancing everything to fluxing dispositions of a boundaries perfection. Environment energy superimposed dynamics (EESD) unbalance the boundaries perfection of balancing everything. The sources and sinks also affect the ultimate longevities of the flowing fluids, conforming quanta and boundaries perfection, the PPLLS and MEHC of Fluid Elements, constituting genus of everything, genera of everything, the boundaries perfection of Advanced Fluid Elements, Advanced Processors and the Earth's gravitational magnetic field, Advanced Processor. All of it constitutes science.

The following lists Domestic Priority data. This application claims these applications:
“a 371 of international” PCT/US2012/000572 Dec. 6, 2012 and
“a 371 of international” PCT/US2012/00319 Jul. 11, 2012 and
   a continuation in part of these applications:
Ser. No. 13/506,098 Mar. 27, 2012 and “a 371 of international” of PCT/US2010/001379 May 10, 2010 and
Ser. No. 13/135,617 Jul. 11, 2011 and “a 371 of international” of PCT/US2010/001379 Mar. 10, 2010 and
Ser. No. 13/136,140 Jul. 25, 2011 and “a 371 of international” of PCT/US2010/001379 May 10, 2010 and
Ser. No. 13/068,587 May 16, 2011 and “a 371 of international” of PCT/US2010/001379 May 10, 2010 and PCT/US2010/001379 May 10, 2010 and
Ser. No. 12/658,099 Feb. 1, 2010 and
PCT/US210/000187 Jan. 25, 2010 and
PCT/US210/000188 Jan. 25, 2010 and
Ser. No. 12/453,444 May 12, 2009 and,
Ser. No. 12/382,448 Mar. 17, 2009 and
Ser. No. 12/320,441 Jan. 26, 2009 and
Ser. No. 12/320,440 Jan. 26, 2009 and
Ser. No. 12/153,036 May 13, 2008 and
Ser. No. 11/809,132 May 31, 2007 and
Ser. No. 11/807,748 May 30, 2007 and
Ser. No. 11/788,172 Jun. 4, 2007 and
Ser. No. 11/724,752 Mar. 15, 2007 and said
Ser. No. 11/809,132 May 31, 2007 and said
Ser. No. 11/807,748 May 30, 2007 and said
Ser. No. 11/788,172 Jun. 4, 2007 and
Ser. No. 11/504,304 Aug. 14, 2006 and
Ser. No. 11/385,078 Mar. 20, 2006 and said
Ser. No. 11/724,752 Mar. 15, 2007 and
Ser. No. 11/418,157 May 3, 2006 and
Ser. No. 11/342,006 Jan. 30, 2006 and
Ser. No. 11/233,546 Sep. 23, 2005 and
Ser. No. 11/212,943 Aug. 25, 2005 and
Ser. No. 11/188,339 Jul. 25, 2005 and
Ser. No. 11/028,982 Jan. 3, 2005 and
Ser. No. 10/869,752 Jun. 16, 2004 and
Ser. No. 10/840,152 May 5, 2004 and
Ser. No. 10/742,485 Dec. 19, 2003 and
Ser. No. 10/190,993 Jul. 8, 2002 and
Ser. No. 10/156,192 May 28, 2002 and
Ser. No. 10/074,966 Feb. 13, 2002 and
Ser. No. 09/850,927 May 8, 2001 and
Ser. No. 09/518,884 Mar. 6, 2000 and
Ser. No. 09/376,957 Aug. 18, 1999 and said
Ser. No. 10/869,752 Jun. 16, 2004 and said
Ser. No. 10/840,152 May 5, 2004 and said
Ser. No. 10/156,192 May 28, 2002 and said
Ser. No. 10/074,966 Feb. 13, 2002 and said
Ser. No. 09/850,927 May 8, 2001 and said
Ser. No. 09/518,884 Mar. 6, 2000 and said
Ser. No. 09/376,957 Aug. 18, 1999 and said
Ser. No. 10/869,752 Jun. 16, 2004 and
Ser. No. 10/195,668 Jul. 15, 2002 and
Ser. No. 10/073,914 Feb. 14, 2002 and said
Ser. No. 09/850,927 May 8, 2001 and said
Ser. No. 09/518,884 Mar. 6, 2000 and said
Ser. No. 09/376,957 Aug. 18, 1999 and said
Ser. No. 10/742,485 Dec. 19, 2003 and said
Ser. No. 10/156,192 May 28, 2002 and said
Ser. No. 10/190,993 Jul. 8, 2002 and said
Ser. No. 10/073,914 Feb. 14, 2002 and said
Ser. No. 10/074,966 Feb. 13, 2002 and said
Ser. No. 09/850,927 May 8, 2001 and said
Ser. No. 09/518,884 Mar. 6, 2000 and said
Ser. No. 09/376,957 Aug. 18, 1999 and said
Ser. No. 09/850,927 May 8, 2001 claims benefit of
60/231,514 Sep. 9, 2000 and claims benefit of
60/226,750 Aug. 21, 2000 and claims benefit of
60/220,358 Jul. 24, 2000 and claims benefit of
60/217,308 Jul. 11, 2000 and said
Ser. No. 09/518,884 Mar. 6, 2000 (contains said Ser. No. 09/376,957 Aug. 18, 1999) and claims benefit of
60/123,504 Mar. 9, 1999 and claims benefit of
60/123,207 Mar. 8, 1999 and claims benefit of
60/123,153 Mar. 6, 1999 and said
Ser. No. 09/376,957 Aug. 18, 1999 and claims benefit of
60/123,504 Mar. 9, 1999 and claims benefit of
60/123,207 Mar. 8, 1999 and claims benefit of
60/123,153 Mar. 6, 1999 and said
Ser. No. 09/376,957 Aug. 18, 1999 and
Ser. No. 08/950,898 Oct. 15, 1997, U.S. Pat. No. 5,941,273

### FIELD OF THE INVENTION

Universe of mass and energy is perfectly balancing everything and is always perfectly balancing.

### BACKGROUND OF THE INVENTION

To account for practical applications of gravitational effects, the theory of relativity must depend on concept of postulating curved space-time that literature documents with agreements and fierce oppositions. Simply put, curvature of space time does not possess dynamics that arise from local quantum energy environmental effects. Such real effects not accounted in the theory of relativity constitute “forbidden mechanisms” non-mechanical or illogical nonzero probability events which are causing chains of such mechanisms whose resolutions herein reveals everything is balancing.

Since the advent of said theory, almost hundred years ago, no utilization is envisioned of curving space time effect. Instead, apparent flaws in the theory are becoming evident, as true solutions to energy issues, within these patent applications, point out and confirm; the Higgs field offers even less and no clue at all as to theorized science potential transferring into a practical energy device.

The prior art classic science, by engendering profoundly flowed the Relativity and Shell Theories and no solutions to the Uniformity and Everything Theories—the four principal theories—spawns deeply flowed everything fluid technologies that effectuate life extinction. All of this is opposed in Tesla fashion by entirely revolutionizing the prior art sciences, technologies and fluids energy.

### SUMMARY OF THE INVENTION

A mass energy balancing of balancing everything in bounding sources and sinks of mass and energy is paths-of-passage (PP) of quantum in and from sources into and in sinks of mass energy having quantal mass and quantum PP lengths, spawning the PP lengths least sum (PPLLS) that is cosmological nullity. A mass energy highest conserving (MEHC) of flowing fluids affirms all of cosmological nullities of the nullity of conforming quanta and ultimate longevities and balancing everything to fluxing dispositions of a boundaries perfection. Environment energy superimposed dynamics (EESD) unbalance the boundaries perfection of balancing everything. The sources and sinks also affect the ultimate longevities of the flowing fluids, conforming quanta and boundaries perfection, the PPLLS and MEHC of Fluid Elements, constituting genus of everything, genera of everything, the boundaries perfection of Advanced Fluid Elements, Advanced Processors and the Earth's gravitational and magnetic field, the Advanced Processor. All of it constitutes science of Fluid Elements ions, isotopes (FEII), associating with principles, methodologies, innovations and inventions (PMII) cosmological (FEIIPMII), global PMII technologies which engender chains of the ultimate longevities that effectuate balancing everything of everything, especially structure of sui generis boundaries that interface with the boundaries perfection of the flowing fluids; all of it is spawning the PPLLS, conforming quanta and MEHC and/or QCMEHC and QCNDMEHC, the flowing fluids' means for balancing the EESD unbalances; all of those are the PMII technologies of cosmological gravitational dynamics to combat the EESD that imperil Earth's viability. PMII, PPLLS, boundaries perfection, MEHC technologies spawn opposition to the EESD and to energy shortage and groundwater depletion; the FEIIPMII, PMII, Fluid Elements, sui generis boundaries constituting PPLLS clustering technologies in energy devices spawns ultimately least or negative backpressures with maximally direct energy flowing from energy sources to or into energy sinks.

The boundaries perfection constitutes quantal tensors of directional and rotational components of mass and energy, of the MEHC and of fluxing fluids and the conforming quanta, which engender fluxing of the PPLLS and conforming quanta and the MEHC, respectively; fluxing of the PPLLS of the conforming quanta affect the PPLLS absolutely least sum and the conforming quanta least mass. Local presence of gravitational force six directions is only two directional; the conforming quanta, centric quintessential core (QC) defines the QCMEHC. Natural dispositions (ND) of the flowing fluids, MEHC and innate frictionless perimeter boundaries define the QCNDMEHC; the (QC) MEHC, QCMEHC, sets forth the flowing fluids uniform, nearly uniform or high pressures.

The MEHC, QCMEHC, QCNDMEHC, MEHC versions, the MEHC, or just MEHC, set forth the flowing fluids in homogeneous uniform, nonhomogeneous nonuniform steady or unsteady flows.

Said FEIIPMII reveal technologies in the Universe of fluids energy utilization maximal functions which breed globose, also, spherical perimeter boundaries of GC Sets that enclose solids, liquids, and gaseous light fluids mass energy. Said globose, spherical boundaries constitute the Universe fluids maximal mass energy forms evolving thru billions of years of light fluids energy dynamics pursuits of the boundaries perfection lowest potential sinks. Quantum mass and energy of quanta travels a straight path, unless altered by energy source, and also transfers from one celestial body to another in least energy demand directional path. Light fluids mass energy quantum paths thru billions of years and infinite repetitions trace the Universe fluids energy evolution of said perfect boundaries and delineations of the Advanced Processors, which also undeniably affirm the PMII.

This significant application advances sciences, applied sciences and technologies thru principles, methodologies, inventions and innovations—the PMII science, technologies—the science, applied sciences quantizing of mass and energy which yields longevity means and revolutionary devices, the MEHC ultimate compliances of light fluids to the First and Second Law of Thermodynamics.

The FMIIPMII, PMII set forth cosmological science by global technology applied science; since the First, Second Law is universal, mass energy genres of the PP, the PPLLS are universal. And, thus, fluxing genres of the PP sustains the conforming quanta, PPLLS and boundaries perfection; anything less than the FMIIPMII, PMII technologies, boundaries perfection is counterproductive.

The paths of passage (PP) that make PP lengths least sum (PPLLS) constituting upright direction lengths embody gravitational force multiple. A cross-section affecting a section of PPLD section demands energy of flow which is opposed by gravitational force; flow energy in horizontal plane requires least energy to flow; in other instances the gravitational field contributes to flow energy.

The PMII merge the First and Second Law of Thermodynamics and amend science and empower technologies. The Second Law, requiring source, sink and flow of mass with energy from source to sink, spawns the fluid dynamics First Law of mass and energy conservation; the flowing fluids of mass energy sources and outflow fluids of mass energy sinks yield the PP in the flowing fluids fluxing environment maximal longevities of the conforming quanta that constitute the boundaries perfection, PPLLS and MEHC technologies of energy by and/or against gravity; a conforming to the PPLLS, MEHC, boundaries perfection and conforming quanta and to a globose conduit (GC) yields structure parameters comprising the sui generis boundaries of the GC Sets, Fluid Elements comprising genus generic genres and the genera of everything. All of celestial bodies disclose it.

The FEIIPMII, PMII technologies, PPLLS, boundaries perfections generic longevities effectuate atomic elements fundamental Fluid Elements, the sui generis boundaries, GC Sets and Advanced Processors; energy sources affect the boundaries perfections, MEHC which yield structure of the FEIIPMII, PMII and defines the Fluid Elements with the PPLLS bred genus genera technologies. Wherein, each of celestial bodies spawns mass and energy diversities of the Advanced Processor.

Parameters of the flowing fluids defining the structure is fully consistent with design of electrical conduits, circuits and circuit boards, wherein flow as current and pressure as voltage correlate the two forms of energy; reversing flowing energy flows, putting the cart before the horse, invariably leads to jaw dropping disregard of cosmological science, the supreme laws of the Nature, such as relegating the Second or the MEHC of the First Law and condoning of the Theories of Relativity and Gravitation or solving global air warming issues before including existences and correlations of the Advanced and fundamental Fluid Elements that spawn boundaries complete complements; the boundaries complete compliments by ions, isotopes or atoms to least quanta mass, the PPLLS and parameters of structures yields devices; reversing of design process, skipping key boundaries or a parameter, which is or are the case with the prior art or sciences yields delusional computing outcomes; works of the brilliant minds, except Tesla's, embrace such outcomes with convictions.

Newton at al, the Shell Theory, misses light fluids ions mass energy causal effects of decoupling, as reaction to global air warming; the Advanced Processor, the Earth, innately utilizes light fluids mass energy to alleviate the magnetosphere magnetic field, boundaries perfection outermost lines energy demands, revealing light fluids demand that currently is imposing on the Earth's viability; the Shell Theory violates fundamentally the Second Law as it imposes orderly and steady state of cosmological flowing of mass and energy and confines the Universe diversities infinite diversity; wherein the Theory assumes the PP of energy outer to inner adjacent Shell, which is not the case.

Energy flowing by the PP bounces around in infinite diversities randomness from the boundaries perfection of a closest celestial body to an adjacent celestial body. All of it is bounded in a larger mass energy of the boundaries perfection, System, or Galaxy. Mass energy of the flowing fluids, PP in spiraling galaxies is spiraling—not at all radial. The Shell Theory violates the Second Law.

Einstein, et al Theories of Relativity build on the Shell Theory violations with curved space time energy in environment, causing present sciences to disregard the Second Law. All that theorizes Kafkaesque unreal mass with energy PP, sources, sinks and diversities of the Second Law, which Newton misplaces, Einstein misapplies, United Nations IPCC disregards, CERN project mislays. But for Tesla's work, all of prior work implies steady state Universe which is profoundly flawed.

Quoting, Sir Arthur Stanley Eddington “The law that entropy always increases holds, I think, the supreme position among the laws of Nature. If someone points out to you that your pet theory of the universe is in disagreement with Maxwell's equations—then so much the worse for Maxwell's equations. If it is found to be contradicted by observation—well, these experimentalists do bungle things sometimes. But if your theory is found to be against the second law of thermodynamics I can give you no hope; there is nothing for it but to collapse in deepest humiliation.” Furthermore the collapse turns into extinction of species, unless applied sciences technologies timely embrace versions of the MEHC and conformance to cosmological law of celestial bodies evolving quanta, which is quantizing galaxies quanta, which in turn, is quantizing the entire Universe and which is analogous with the atomic elements, fundamental Fluid Elements mass and energy quantizing on fundamental levels; the Second Elements embody the First Fluid engendering cosmological mass energy quantizing into genus genera, evolving optimally least quanta mass of the Fluid Elements.

The Second Law sets forth mass energy extremely unpredictable and infinite diversities of the PP which spontaneously with the First Law yields forbidden mechanisms which in fact is the EESD. Classic Theories, prior research stunningly ignore and slight the Second Law and thus are deeply flawed, revealing most if not the entire prior art a jaw dropping, abashing, stunning inadvertence.

An energy essence of the PPLLS conforms to alternating or direct current or any forms of energy fluxing in flowing of fluids energy inside the boundaries perfection which constitutes the flowing fluids optimal to maximal coupling, grounding of the MEHC low to least resistance paths, the PP lengths, to anywhere gravitational sinks. The flowing fluids, MEHC, PPLLS, conforming quanta yield seamless universal technologies and apply in entirety to flowing electrons energy, requiring low, least or negative backpressures an ultimate grounding of electrical devices or circuit boards, conforming to the PP, PPLLS and to diversities randomness which embodies a source and a sink.

The sui generis boundaries spawning surfaces and figures of FESD inventions affects the PPLLS restrained, low, maximally least, nullity or negative backpressures of or at gravitational sinks, the conforming quanta fluxing least mass maximal longevities and the boundaries perfection of mass energy, which, in turn, yields dynamics of the flowing fluids that yield boundaries of the MEHC.

A structure of the PMII, PPLLS technologies yields perfections of the electrons, atoms and Fluid Elements and their clustering into the MEHC of the Advanced Processors, as in magnetospheres. The FESD inventions overlying the boundaries perfection spawn the PPLLS absolutely least sum with a PPLD band an absolutely least length and the conforming quanta an absolutely least mass.

Energy in environment and work of energy sources by or against the gravitational field bound by the boundaries perfection comprise energy of work by the PPLLS all directional and/or rotational components of quantum quantized energy of conforming quanta work energy. Paths-of-passage-of-least-energy-demand, the PPLD, which embody least energy needed to spawn passage, denote flowing energy changing from contributed energy to demanded energy by the gravitational force.

An eternal nullity PPLLS, the PPLLS nullity, boundaries perfection, genus generic genres spawn genera that spawn the PP of quantum mass energy to precise nullities of the PPLLS, to effectuate the boundaries perfection and eternal longevities. The Universe, nonradioactive atomic elements disclose the boundaries perfection and inside each the precise nullities, PPLLS which spawns the conforming quanta, boundaries perfection and eternal longevities which colligate the conforming quanta, MEHC and PPLLS to the eternal longevities, PPLLS affecting the boundaries perfection.

Science of the cosmological balances comprises: longevities of the flowing fluids and boundaries perfection of the conforming quanta, MEHC embodying genus everything genera everything and infinite clustering of the Advanced and fundamental and Fluid Elements, cosmological nullity of the PPLLS balancing of the boundaries perfection to the Thermodynamics Second and First Law. The cosmological balances affect continual balancing of the EESD; in mass energy environment, work done is always the cosmological nullity and prima facie credibility of balancing everything.

Since flowing of mass and energy inside the boundaries perfection remain balanced to accuracies of quantum, that mass and energy spawns boundaries by balancing mass and energy to effectuate nullity. Testing of the prior scientific theories against prima facie credibility of net work nullities collapses the theories existence. The Shell Theory has no means for affecting circulation of mass and energy, and thus theorizes the Universe that spawns mass and energy work done in balancing of itself; that not only violates the Second but the First Law, also. The Relativity Theories spawn same oversights and also theorize eternal curving of space and time that has no sources and sinks or circulation of energy; all that is huge violations of the First and the Second Law. Similarly the CERN project does not bother with sources, sinks and circulation within boundaries of perfection of atoms that enslaves God particle. The UN, IPCC defines AGW conclusions by pointing to the CO₂ and its emissions and concentrations in the atmosphere. Close look at CO₂ mass energy that spawns global heat circulations now and did in the past can only conclude that enormously larger forces are at work; the forces of climate change are those which the Milankovich cycles disclose.

There just is no means for the CO₂ in the atmosphere to affect energy of advancing and retreating glaciers and polar ice caps, whose millennia ice cores is correlating CO₂ and global temperatures. That points to causal effects present enormous mass energy which is fluxing global masses of ice and atmosphere temperatures during glacial, interglacial periods and CO₂ concentrations, as well.

Unrelenting effects of energy in environment which spawns superimposing of energy, the EESD, mainly mass and energy of the cosmological balances of gravitational dynamics which, likewise, include heat of vaporization of sublimation, of freezing, melting, of condensation, deposition and of ionization, recombination as heat energy processes embodying phases step changes from solid state to plasma state; these comprise buoyancy, combustion, erosion, friction, releases of gas and also force stratifications, gradations processes and destruction of the boundaries perfection of the Fluid Elements and Advanced Processors. AGW belongs in this category but only as newcomer.

Pointing to AGW as cause of changes in environment is historically inaccurate and inappropriate and is not fairly addressing issues of global civilizations survival in mass and energy confronting forces of the EESD; no way energy that the 0.039% CO₂ of atmospheric mass spawns glacial and interglacial periods. In said confronting, controlling emissions of CO₂ alone has no chance at all.

What needs to happen is the PMII, PPLLS technologies that yield the conforming quanta, MEHC and boundaries perfection that yield the PP shortest directionality from environment into epigene mass, embodying mass energy transfers to epigene mass and not into generating of plasma fluids.

The PPLLS, spawning the PP shortest paths of mass energy circulating from and into the epigene mass, affect maximal coupling of light fluids, hydrogen/oxygen water vapors and nitrogen, to the gravitational sink. That reduces gravitational dynamics of the light fluids and CO₂ participations in the EESD dynamics and avoids the PP of the light fluids toward mass energy of plasma. That, again, correlates with electrical energy work in electrical circuits. All of that requires grounding, wherein potential nonstandard grounding spawns shorting demise in conduit of electrical energy.

Again, the correlations hold, since the flowing fluids undefined mass and energy PP not coupling to epigene mass force the EESD mass and energy PP potential conduits into plasma mass energy. The entire prior renewable clean energy spawns undefined mass and energy PP, which engenders the flowing fluids rerouting from flows into the gravitational sink to nonstandard PP flow toward mass energy of plasma. That establishes renewable clean energy as energy source that is sapping energy of the gravitational and magnetic fields and is detaining thermal energy in environment of stagnating PP of undesirable conforming to the cosmological balances of gravitational dynamics.

The byproduct of heat energy in stagnated environment raises temperature of mass energy that is containing it and affects the EESD that spawn the gravitational dynamics upward PP, away from the gravitational sink and towards plasma mass and energy; the upward PP generates greenhouse gases and ionization of the light fluids and comprise potencies and quantities that exceed those of CO₂ emissions. All of it saps energy from the gravitational and magnetic fields. The entire prior art offers no hope of survival. Only, fluid devices comprising the conforming quanta, boundaries perfection and PPLLS, including nuclear super plant (SP) technologies, are abolishing the EESD.

The issues of the entire prior art arise from its utilizations of the atmosphere as gravitational sink. That accumulates energy of all byproducts including those released by fauna and flora; the EESD accumulates and affects environment energy dynamics that affect the boundaries perfection. The cosmological balances of gravitational dynamics include balancing of everything—the EESD and cosmological gravitational dynamics mass energy—all of which yields the cosmological nullities. Milankovich cycles extract the EESD superimposed dynamics energy from the gravitational and magnetic fields fluxing energy of the boundaries perfection to reveal the prior art stunning flaws.

The priority applications cite a critical flaw in the Theory of the Newtonian gravitation which the Theories of Relativity exasperate; all of the prior theories snub the Second Law and thus the First and Second Laws in spite of Tesla's profound warnings. Likewise, the entire prior art snubs two of most supreme laws of Nature, the First, Second Law; wherein abuses of the First, Second Law in three hundred years since Newton highly jeopardize life on Earth; top environmentalists see it. However, enormous differences exist between emissions energy of greenhouse gases and energy of mass of the cosmological balances that spawn the cosmological nullities; the latter is absolute.

The Earth stratifying fluids evolve forms equal functions globose boundaries, as the gravitational sink and the magnetic field shield molecular, atomic, and plasma fluids bound by magnetosphere boundaries enormous fluxing from solar, cosmic wind pressures and radiations; the Universe, the boundaries perfection embody diversities randomness (EESDBPEDR) by distributing the EESD; in forbidden mechanisms realm, most deceiving is when mass energy demands last for billions of years; in polarities switch, planet becomes energy source or star becomes energy sink, with fluids mass and energy higher densities dominating forbidden mechanism processes forced boundary; a gravitational sink, gravity force effectuates fluids mass energy evolution quests, seeking a lowest potential mass and energy sink which continuously spawns effects in celestial dynamics common cause search for the Universe mass energy balance, only achievable with forced lowest potentials of light fluids mass and energy; normally, a planet mass and energy force sink prohibits loosing a part of its mass even if subatomic, which requires polarity switch in forbidden mechanisms and a forcing of a source mass energy functions. A polarity switching tests celestial dynamics wherein bodies merge or separate more, illustrating mass energy evolutions incredibly balanced Universe.

In genus genera genres correlation, history of epigene geology reveals that the EESD continually forces fluids to evaporate and spawn environment pressures in the magnetosphere, which distend its boundaries, spawn magnetic cusp means for flowing-out fluids that ameliorate built pressures.

The Universe evolves and distributes four phases of matter, including Bose Einstein condensates, with its flowing fluids mass energy redistributions, into sinks of lower potential energy levels. It is therefore correct to think of gravitation as embodying gravitational and environment dynamics low potential energy sinks and the gravitational constant formula embodying sciences time frame snap-shot of two gravitational sinks gravitational attraction as entirely lacking needed exactitude.

Milankovich cycles in graphical presentation reveals the EESD and glaciation stages temperature peaks immediately followed by a sharp drop in temperature, forced by causal effects of magnetic field outermost lines break-off events as gravitational dynamics Jean's fountains blow-offs along the Solar System disk plane due to the EESD and environment dynamics maximal superposition.

The EESD propagate energy in waves, spawning temperature amplitudes, in respect to disk plane of the Solar System; on Earth, the waves and amplitudes affect Milankovich cycles that dissipate in intensity with distances from the Sun and dissolve in evolving the boundaries perfection of the Solar System. Currently, the Earth ice recedes; the Mercury, Venus light fluids evaporate; in the Solar System, phases of the other Planets yield the light fluids surficial ice. Surficial stratigraphy of geologic formations show that at one time ice, water respectively covered surface of the Earth, Mars. The light fluids in lightest phase, configuring energy in cosmic environment, comprise the boundaries perfection of the conforming quanta respective densities, dispositions and longevities imposed by propagating magnitude of the EESD. As temperature amplitudes in the Milankovich cycles, the EESD propagating as waves of thermal energy graphically illustrates causal effects on epigene features that also impact on the Earth's gravitational and magnetic fields. Convolving of the cycles for presence of the light fluids appears as an anomaly; wherein, Mercury, Venus, Mars have none while water predominantly binds epigene of the Earth. And, that is not the case, at all.

The Earth's abundance of water points to unbelievable balance of the Solar System wherein each of its bodies comprises cyclic, fluxing mass energy approximations of the cosmological nullity of the conforming quanta including the EESD inside its boundaries. The conforming quanta, which comprise significant mass of epigene water and means for longevity of the light fluids, spawn the conforming quanta least longevity of such compositions within longevities of cosmological time; at first glance, said cycles convolving appears limited, wherein, again, such is not the case, at all.

Extensive observations of the observable Universe has yet to disclose another celestial body with flowing water. That conclusive explains enormous fluxing of the magnetosphere boundaries that sustains the conforming quanta by affecting Jean's fountains plasma outflows. That counters the EESD as it conserves the flowing fluids of the conforming quanta. That boundaries perfection, if it were to collapse, embodies miniscule energy of the EESD within the conforming quanta which affect the cosmological nullity of the Solar System mass and energy. Outflows of the light fluids from the conforming quanta of Mercury, Venus, Mars, Earth and Moon give credence to the light fluids outflow from the conforming quanta and boundaries perfection of the Solar System. All of that points to the Earth's magnetosphere, engendering phases and compositions of the light fluids in unique abundance, as weakest link in planetary chains of the boundaries perfection embodying unique source of the light fluids. In turn, Milankovich cycles illustrate effect of the EESD which force Earth cycles of climate changes, as cosmological dynamics mass and energy balancing that invariably promptly burdens boundaries of the light fluids; and, that explains lost fluids by Mars.

By happenstances of the EESD and respectively weak Mars' boundaries perfection much weaker than Earth's boundaries perfection preserves life on Earth. The light fluids of the two Planets are insignificant in balancing the boundaries perfection of the Solar System that also appears to leak.

The PP of plasma outflow are tied by the cosmological nullity to the boundaries perfection of the Earth's magnetosphere, its longevity and its existence, which is of concern, as it is surrounded by planets which lost possession of light fluids, and the Earth is loosing hers. Such PP forces chains of forbidden mechanisms mass energy forcing of plasma fountains outflow by decoupling, which subsequently affect cycles of climate changes, with extreme climate events and glaciation cycles; wherein the Earth's water loss best estimate is about 25% of its water budget. All of the above is truly astounding with realization that evapotranspiration affects the loss, which follows hydrogen followed by nitrogen escape aside of the water budget, only totaling portions of the oxygen entire losses; nitrogen lost to deep space is not known; as it makes up 78% of the atmosphere, its losses are significant, also. All of it discloses that the Earth, a planet, is significant cosmological source rather than gravitational sink of the light fluids. Six of the continents as land mass clusters of the Advanced Processors constitute low groundwater levels in respect to entire budget of fresh water needed to support global fauna and flora and growing population; continents land mass is mainly in the northern hemisphere, affecting light fluids escape thru the cusp of the magnetic field above North Pole. The light fluids escape cools the entire atmosphere, wherein the EESD spawning the North Pole plasma fountains effectuate precipitations at the South Pole and no plasma outflows—thereto, spawning a coupling of light fluids, the polar ice cap and epigene crust. Thus, the EESD and such dynamics of gravitational units spawn means for changing dispositions of the magnetic, geographic poles, known to have occurred in the past. Said means affect balancing of the Earth's gravitational sink and magnetic field engendered rebalancing of angular momentum dispositions.

Everything known about the light fluids relates to geology, especially epigene geology; estimates of Earth losses of the light fluids go back no further than the magnetic field's current disposition. That includes composition of the atmosphere. CO₂ mass and energy content in the atmosphere is much too small to affect climate changes. No doubt about it, whatsoever. Temperature changes, which the IPCC correlates with presence of CO₂, in fact, correlates causal effects in environment of the EESD in the magnetosphere; that correlates with CO₂ buoyancy that is sufficiently close to those of the light fluids and presence of the EESD which spawns the PP of the light fluids toward the plasma mass energy, which slows CO₂ returning to epigene gravitational sink. It is energy of the EESD that correlates to global temperatures; CO₂ concentration rises conservatively correlate to dynamics of the EESD in glacial periods. CO₂ concentrations, global air temperatures diverge in interglacial period later stages and plasma mass energy outflows; the EESD flux concentration of CO₂ in air. The EESD mass and energy embody awesome capacities; they force the balancing of balancing everything, cosmological nullities. Outflows plasma of the light fluids spawn lower global air temperatures, relieving EESD energy and pressures in the boundaries perfection and in the magnetosphere to spawn the cosmological nullity. CO₂ concentrations increase and correlate conservatively to dynamics of the EESD, as CO₂ concentrations, global air temperatures diverge.

The EESD feed outflow plasma, the boundaries perfection of the Solar System gravitational sink. Global community incomprehensibly underestimates presence of the EESD awesome energy and momentum that assails innately energy and momentum which embody weakest of the boundaries perfection. The Earth's magnetosphere, boundaries perfection comprising abundance of the light fluids becomes a prime target in the Solar System, by protecting the light fluids from the nullities in the Milky Way Galaxy responding to the EESD; scientific community in assessing greenhouse gases in environment firmly concludes that the Earth is decades from a tipping point of no return; that applies to the EESD to which it pertains. Conforming quanta, boundaries perfection, PPLLS technologies which effectuate the ultimate longevities of the devices to offer a potential survival; however, the technologies need decades to develop momentum that opposes effects of the EESD. In difference to the prior gravitational theories science, gravitation dynamics engender means for recurring environment cycles of the flowing fluids changing phases, volumes and energy level in environment of celestial bodies and plasma distributions among gravitational sinks, which affects the boundaries perfection and diversities of gravitational units, phases and potential energy. That and lowering potential energy of gravitational sinks of the boundaries perfections affects celestial bodies, the Advanced Fluid Elements respective boundaries. Within magnetic fields, densities of the light fluids evolve gravitational sink functions lowest potential levels and the Advanced Fluid Elements, Advanced Processors, MEHC spawned paradigms of the boundaries perfection forcing forms thru functions equal forms; processes of stratifications and gradations remove energy from compounds; forbidden mechanisms transform vapors into plasma that outflows thru the magnetic field cusps to spawn the Earth periodic lowering of potential energy levels. The EESD streaming plasma continuums of energy flux in the past and into the future evolves, balances the boundaries perfection of everything, the Advanced Processors and Fluid Elements—the genera of everything.

A frozen surface gravitational mass unit of a planet yields the boundaries perfection an indefinite longevity; boulders, wash gravel and round sand grains affect respective gravitational boundaries constituted longevities, forced by climate changes in environment, wherein the letter boundary is derived from the prior boundary environmentally inflicted breakups. Atomic elements constitute the boundaries perfection that breaks down on extremely rare occasions and, therefore, is eternal. Hydrogen as the first atomic element is also the whole gravitational unit of smallest eternal mass.

Explaining geological features and astronomical phenomena is in the prior applications; wherein, gravitational, magnetic fields dynamics and environment energy superimposing of dynamics, the EESD, spawn in unison environment mass energy dynamics, Universe omnipresent cosmological dynamics of gravitational units that evolve in-situ fluxing dynamics of the boundaries perfection.

The flowing fluids unit energy bound in cosmological gravitational units and the clustering of the Fluid Elements, Advanced Processors, genus genera transposes configurations of a GC structure; genera boundaries perfection and everything longevities spawn additional undefined randomness of cosmological diversities. The light fluids, boundaries perfection affecting magnetic fields and longevities of EESD fields can affect atmosphere of the light fluids by Fluid Elements clustering. Atomic elements, plasmas and the Universe cosmological nullities engender the EESD streaming mass continuums and eternally fluxing plasmas, balance the boundaries perfection of everything, the genera of everything, and spawn the cosmological gravitational dynamics. The cosmological nullities yield the genera of everything, the Advanced Fluid Elements, which resolves the Theory of Gravitational Dynamics. All of it resolves the Theory of Uniformity; wherein, solutions to the two Theories, the EESD, the Advanced Fluid Elements and cosmological nullity engendering the boundaries perfection solve the Theory of Everything. That solves The Three Theories; wherein, universally stunning uniformity is omnipresent demands for light fluids energy. From infinity of space to infinitesimal detail, discloses the fundamental Fluid Elements, the solutions to the Three Theories and the civilizations survival highly limited principal options solitarily course of action.

Shrinking water sources and regulating CO₂ emission cuts cannot effectively conserve water; the sui generis boundaries in ubiquitous devices timely maximal benefit avoid a doomsday scenario. The flowing fluids, conforming quanta, PPLLS, boundaries perfection maximal conformances to the Second, First Law embody the boundaries perfection, devices that yield maximal longevities.

Geology, astronomy science validates the FEIIPMII, PMII, fluxing fluids, boundaries perfections and applied technologies science conforming to gravitational dynamics that yield functions equal forms of inorganic Atomic and Fluid Elements and organic one cell forms and clustering of these into inorganic and organic Advanced Processors, which comprise the magnetosphere boundaries.

Holes in the ozone layer, proximate of and above the magnetic poles, in the magnetosphere cusps disclose frailties of and strains in the magnetosphere, boundaries perfection wherein dynamics of the ozone layer is not attaining closure. In genus correlations, epigene genres disclose the EESD evaporate and release fluids that breed environment pressures in the magnetosphere, which force fluids distended boundaries fluids outflows thru magnetic field means for out-flowing fluids. As magnetic cusp lee side shoulder causes suction, the magnetic field lines bound atmospheric fluids blow-off, and when suction persists it siphons fluids inside the magnetic field. In a full blow-off, the magnetic field and the atmosphere entirely collapse. Subsequently, breeding of light fluids in a lengthy glaciation period affects a new magnetic field and a new disposition bred by the EESD.

The ozone Holes reveal dynamics of that layer, embodying continuous inflowing and outflows of oxygen ions, embodying evidence that light fluids of hydrogen and oxygen Ions escape in spurts. The Moon's progressive escape from the Earth's gravitational sink field attests to enormous light plasma escape from both, effectuating progressions in evolution of the Earth's gravitational sink.

Milankovich cycles leave no doubt whatsoever; the Earth gravitational and magnetic fields as the boundary perfection of the Advanced Processors is not able to configure the cosmological nullity of eternal boundary that stays the light fluids; monitoring of the Universe is yet to locate a planet that is even close to ability of the Earth's system to retain water; said cycles graphically illustrate failures to affect balance of the cosmological nullity, shown by CO₂ presence in ice cores. These cores and astronomical observations disclose that the boundaries perfection of Planets eternity in general is an entirely frozen mass or shows no light fluids, wherein the Earth is unique exception.

Said cycles affirm that interglacial period disunites the Earth's boundaries from the cosmological nullity, engenders plasma blow-offs and moves the Earth toward optimally glacial default stages. In the cusps of the magnetic field, especially at shoulder of the cusps, the light fluids spawn flow in direction according to the First and Second Law of Thermodynamics; that is in direction of its gravitational sink. In respect to the Sun, the Earth's lee side experiences drag, suction, especially behind plasma fountains, while atmospheric pressures towards epigene surface rise to of 14.7 psi.

Thus, the Earth's boundaries leak, unless its surface is entirely frozen and cools its atmosphere to environment energy below threshold of the EESD forcing of plasma outflow by Jean's fountains. The interglacial period spawns energy of the EESD, which engages the atmosphere's entire mass in global air warming temperatures rise; the CO₂ 0.039% of the atmospheric mass and energy are insignificant in comparison to the EESD in environment and profoundly irrelevant in comparison to mass and energy that impose the boundaries perfection of cosmological and the Earth nullities.

The clean energy does not reduce energy of the EESD. Solar energy takes energy that affects the magnetic field outermost crucial lines and leaves all fluids in the atmosphere; wind power energy loses gravitational mass by sustaining, keeping all gases in the atmosphere; both stoke the EESD.

Each of the boundaries perfection has its gravitational sink which cannot define mass and energy of a celestial body but centers of mass and energy which act in unison and comprise gravitational sink. The Sun embodies gravitational sinks two centers; one reflects the boundaries perfection of its mass energy; the other embodies entire mass energy of the Solar System wherein mass energy of the Sun's gravitational sink penetrates inside the boundaries perfection of any planet. Emitted energy by each planet opposes force of its gravitational sink wherein the flowing fluids energy in environment, gravitational field dynamics and magnetic field fluxing spawn energy of the EESD. The EESD in general act against gravity, which devitalizes the gravitational force embodying net effects which are dynamic and not static in respect to the PPLLS to anywhere gravitational sinks.

The Sun in the Solar System spawns gravitational dynamics and the light fluids energy dynamics in the cusps of the Earth's magnetic field. These energy dynamics superimposed on the EESD in the atmosphere spawn plasmas fountains, which squirt into the boundaries perfection of the Solar System. When energy of the Sun is overpowering all effects of gravity, it generally drives out all the light fluids; wherein, the Solar System sends only the light fluids into the Milky Way Galaxy.

Aforesaid reveal applied sciences facts that expose most significant profoundly deep flaws of the aforesaid theories on gravitation—the Earth is not in command of any rights to atmospheric mass, other than the precipitations. The light fluids significant mass that the Earth lost and continues to loose attests to it; the Earth's gravitational field which promptly looses hydrogen atoms is best of examples. Thus the cosmos has future claims to the light fluids of the Earth's entire atmosphere; that and the disclosure of the cosmological nullity and nullities makes defunct the entire prior art. The Earth is going to embody the cosmological nullity without the atmosphere, or with “it”. The detailed basics, herein, differentiate the technologies with “it”; otherwise a Mars scenario arrives.

Only precipitation effects can quell the light fluids in the gravitational sink and dynamics causing the EESD to take the light fluids out of the magnetic field; that defines the Earth's magnetic field as the light fluids detention basin; the Earth is source not sink of the light fluids as established by inventory of the light fluids. Especially, Mars epigene fluvial features affirm that. If comprising of the light fluids, the planets are detention basins; they blow-off violently, as is likely in case of Mars. Except for Tesla and Milankovich, the entire prior art and science, all of it, presumes that the Earth's atmosphere is exclusively mass and energy of the Earth's gravitational sink. And that is profoundly not the case at all. In fact, energy of the Sun makes the atmosphere's mass energy an extension of gravitational sinks not in the Solar System, generally associated with Black Hole.

The FEIIPMII, PMII technologies spawn atmospheric mass through precipitation constituting the conforming quanta, MEHC, boundaries perfection and PPLLS technologies of the flowing fluids, to engender means for in parts transferring thermal energy of that mass into epigene crustal mass. These impose maximal conformances to the Second Law, unexplainably snubbed in the prior art. The PMII technologies boost the gravitational and magnetic fields in their boundaries perfection.

An absolute device, a region has flowing mass and energy of quantum or electron subdividing flowing mass energy of quanta which takes a path least length of path lengths that make quantum or electrons a paths-of-passage lengths sum (PPLS), lengths of quantum or electron energy paths, which constitute mass and energy of the subdivided quanta. Minimizing the PPLS to a least sum (PPLLS) spawns the boundaries perfection of conforming quanta, the region and the least energy demanded by the path lengths; the conforming quanta spawned an optimal to absolute sum of the PPLLS yields an optimal to absolute energy, respective least energy; the absolute device, region, conforming quanta, boundaries perfection affects cosmologically least energy of absolute energy.

The absolute device as a technology unit makes path lengths of the path length in series and/or in parallel increments that comprise a clustering of the absolute device wherein the absolute device, the region, the conforming quanta and the clustering of boundaries enlarges in steps; the absolute device, in increments of absolute device, incorporates into an electrical conduit, circuit boards, or an energy device; the absolute device with cosmologically least energy in increments amends the conforming quanta, region profound flaws in a monitor, a screen, a phone and any energy device.

Mass and energy essences of the boundaries perfection region, by constituting the PPLLS, spawn a cosmological absolute conductivity region of an alternating, a direct current, or an energy flow; wherein an electron mass is indivisible, the cosmologically absolute conductivity is unmatchable. The absolute device, the increments that positively amends flaws elite can dub God's increments.

The absolute device spawns boundaries of the region comprising a gravitational unit boundary of a quantum or an electron comprising centerline of the path least length coinciding with centerline of a concentric clustering, to extend longitudinally along a centerline of the concentric clustering.

Absolute devices in an absolute maximal number make entirely round cross-sections constituting quantum quantized quanta or number or electrons flowing through the cross-sections constituting complying quanta of clustered cross-sections and the path least length, PPLLS clustering inside a clustered boundaries perfection region of the clustered cross-sections. A flow rate of electrons of electrical current or of the quantum quantized quanta through a clustered cross-section comprises the complying quanta and a diameter of the clustered cross-section; a least flow rate sets forth the clustered cross-sections flow rates and diameters in each of the clustered cross-sections spawning longitudinally a length of the clustered cross-sections of the path least length extended in a series of steps extending longitudinally the clustered cross-sections and clustered boundaries perfection region. Lengths' diameters of a clustered region in a series and the least flow rate in each and all absolute devices and clustered diameters and in lengths of the path least length in a series make a length of the clustered region. That binds volume of the absolute device into an absolute devices assembly in a volume inside coincident boundaries of the complete absolute device assembly and a region engendering structure inner surfaces, which, likewise, bundled in a series and/or parallel assemblies of the complete absolute device assembly makes a region and a coincident boundaries perfection of an advanced assembly region, an advanced assembly of the absolute devices and an advanced structure inner surfaces. Perfectly balanced energy source, sink constituting a quantum quantized quanta complete complements of a quantum mass energy, number of electrons flowing in each of the perfect devices maximize longevity of the source, sink and the advanced assembly.

The PMII technologies, cosmological gravitation dynamics, boundaries perfection yield maximal longevities of everything and conserve mass energy of the light fluids including electrons energy. Cosmological energy density, space energy in environment per unit volume evolves to low levels as celestial bodies absorb environment energy by amending the boundaries perfection, spawning high definition energy boundaries and strengthening respective energy fields; and that is what the absolute device does. The cosmological energy density points to two profound and deep flaws in the entire prior art, except for Tesla's inventions. First and foremost, all of said prior art practice uses the atmosphere's conductivity as the gravitational sink, which it is not. Except for effects of precipitating force, innate direction of the conductivity is toward the magnetic field cusps against all common rational. Second, the prior art is entirely void of boundaries perfection technologies, which invariably boosts the cosmological energy density of the atmosphere to force its outflows. Rather than contributing, to the Earth's energy fields, that prior art damages their crucial viability.

The prior art unexplainably snubs the absolute device absolute conformances to the Second Law. Conforming quanta, PPLLS technologies and absolute conformances to the Second Law compete absolutely in the light fluids cosmological mass energy cycling demands that balance everything. And that makes the entire prior art profoundly deadly, except for Tesla's inventions and science. The technologies maximize mass and energy conductivities towards anywhere mass energy sink. The conductivities transfers mass energy in environment from the flowing fluid of the EESD into the gravitational sink consuming the EESD which spawn evaporations and lack of precipitations, cycling of the flowing fluids that slows evaporations of epigene water; the conductivities reverse: energy of evaporation, the EESD spawning environment gases and cooling of the Earth's mantle; the technologies spawn energy means for transposing of the fluids in the atmosphere into epigene groundwater wherein cumulative effects slows momentum of the EESD accelerating momentum. Said cumulative effects must accrue fast thru many decades to overtake momentum of the EESD; the technologies maximizes an electron path, electrons' paths and or flowing fluids mass energy.

The technologies working on 100% of the atmosphere's masses total versus 0.039% of CO₂ mass present in the atmosphere yield 25,000 times more chance of success on mass percentages, alone; The top environmentalists favor nuclear power and warn of the Earth's tipping point of no return, as it is becoming abundantly apparent that regulating part of CO₂ cannot possibly achieve results.

The Earth's Advanced Processor gravitational filed, magnetic field couples epigene groundwater, polar caps and glaciers less couples oceans and continental waters only partially couples fluids of the atmosphere and least couples ionosphere masses, as magnetosphere quanta of the light fluids; the PPLLS, conforming quanta, boundaries perfection in traversing domains of genus everything genera everything spawns Advance Processors, Fluid Elements and fundamental Fluid Elements.

In traversing across domains, the PPLLS of the conforming quanta is the PP least lengths sum of the boundaries perfection. The PP in the boundaries perfection is the PPLLS. Mass spawning of the boundaries perfection is the conforming quanta; all of domains affect the light fluids, MEHC; tracings of boundaries perfection, conforming quanta and PPLLS technologies transpose volume mass yielding diversities randomness of conforming embodiments and the MEHC, genus genera.

Everything living on epigene surface and the surface itself emits byproducts of existence into the atmosphere and taking it as the gravitational sink, wherein, as it turns out, is not the case, indeed. The Earth is left the task of affecting energy that precipitates the byproducts from the atmosphere to the gravitational sink; Milankovich cycles imposed geologic history shows the Earth unable to entirely conserve its atmospheric mass. Thus, interglacial periods culminate in a return to default setting by blowing-off part or all of its atmosphere, which is lowering overall mass of the Earth's gravitational sink. It appears the Earth is capable of restoring atmosphere as long as it has water, which in fact, uses the Sun's energy means for recharging the detention basin, the magnetic field.

The recharging of the magnetic field and its discharging cycles are illustrated, likewise, by cycles of interglacial, glacial periods, respectively; best timed by mountain glaciers melting or build up; the technologies yield energy transfers to avoid the Sun's means for charging the detention basin.

Once water vapor enters recharging, discharging cycles, it partly decouples, and any of that mass in ionosphere least couples to the Earth's gravitational sink, as the EESD boost energy of vapors. There is no evidence whatsoever that the Earth's innate processes can remove permanently water vapor from the recharging discharging cycles, which generates outflow of the ionosphere plasma.

Retaining vapor till it liquefies is only means for keeping the light fluids in the gravitational sink. In electrical power generation of a nuclear SP, water vapors condense in underground aqueducts; the cosmos is everything anyplace mass energy mean maximal MEHC machine; a device MEHC with less than maximal grounding conductivity to the Earth's gravitational sink is deeply flawed. Zero emissions and clean energy of the nuclear SP is maximally efficient bulk energy generation, affecting maximal efficiencies that are limited only by configuring of heavy equipment available.

Wind power energy yields clean energy. But, it does not condense an atmospheric mass volume. That takes precipitation energy, the PP to the gravitational sink; since the Sun's energy generates the EESD from any mass that responds to its radiations, especially gaseous mass, the Earth is left to its means for replacing energy of wind energy and it does that by mass of the plasma outflows, simultaneously relegating the Earth's gravitational sink to those of the magnetic field cusps; thus, wind power energy consumes radiation transparent plasma mass with energy. That, in turn, stays most powerful triatomic gases in the atmosphere subject to superimposition of the EESD energy.

Effective precipitation of water vapors also precipitates in part other triatomic gases, wherein the wind generation causes precipitations delay which sustains quantity of all vapors. In generalized overall statement, it is very likely that the wind power energy is more deleterious than beneficial. Solar and wind energy generation sap energy that empowers gravitational sink, with conclusively nothing to safeguard, contain the light fluids gravitational coupling with precipitations dynamics.

The boundaries perfection spawns the Universe mass energy everything from atomic elements to Black Holes, wherein the Earth's magnetosphere magnetic field lines effectuating paradigm of in situ—functions equal forms—spawning the boundaries perfection instantly taken dispositions; the functions transpose the GC Sets taken dispositions by fluxing forms of the boundaries perfection.

The advanced Processor mass energy, embodying magnetic field shielded quanta mass functions, embodies: the advanced Processor Fluid Elements, Isotopes, and Ions and living organisms fluids mass densities magnetic field lines magnetic poles two cusps inverted from inside the ionosphere and electrically charged stratosphere and upper atmosphere; the two cusps embody generic forms of electromagnetic field lines of a globose inverse offset centric GC Set, affecting an open mouth two Inlets interchangeable with an orifice two outlets or an orifice outlet interchangeable with an open mouth Inlet, which constitute parts of the boundaries perfection of the Advanced Processor.

The flowing fluids, PP, PPLLS and conforming quanta in omnidirectional environment comprise low to negative backpressures embodying the PPLLS, MEHC versions to anywhere gravitational sink; since the First, Second Law is universal, mass energy genres of the PP, PPLLS is universal; thus, genres of parameters correlate the Advanced Processors to the fundamental Fluid Elements.

A fundamental Fluid Element embodies genres of a First and a Second Fluid Element, a Set, and the Second affects genres of the First Fluid Element, associating with a drain trap apparatus and a drain line, a drainage line or a drainage system; the Second Fluid Element comprising:

An Inlet, a basin and an outlet and means for detaining, retaining and releasing fluxing flowing fluids.

The Inlet is capable of accepting in flowing, releasing outflow of fluxing flowing fluids, to maintain submerged an unchanging mass volume retention region in the Inlet.

The basin associated with the Inlet is capable of accepting in flowing, releasing outflow of the fluxing flowing fluids, to maintain submerged an unchanging mass volume retention region in the basin.

The outlet associated with the basin is capable of accepting in flowing and releasing outflow of the fluxing flowing fluids to maintain submerged an unchanging mass volume retention region in the outlet;
an unchanging mass volume retention region comprising of unchanging mass volume retention regions comprising least mass volume of the fluxing flowing fluids, a retention, retained in the Inlet, basin and outlet;
a fluxing detention region capable of detaining a fluxing mass volume, a detention, comprising the fluxing flowing fluids respective mass volume detained in the Inlet, basin, outlet;
means for maintaining an entire undersurfaces of an End 2 of the Inlet or a First End of the outlet submerged in the fluxing flowing fluids retained in the unchanging mass volume retention region of the basin;
an undersurface of the End 2 of the Inlet or the First End of the outlet and in a curving upright surface plane of symmetry effectuated a PAP Line, or said End 2 or said First End submerged in the unchanging mass volume retention region of the basin classifying a hybrid, a globose, a globose inverse structure respective domain of the sui generis boundaries perfection, the Second Fluid Element;
a fluxing quantized quanta region equaling the unchanging mass volume retention and the fluxing detention regions;
the fluxing quantized quanta region subdivided into mass energy quantum constituting a paths-of-passage (PP) lengths least sum (PPLLS) of the PP concurrent mass energy paths effectuating a passage of the fluxing flowing fluids detained mass and energy in the fluxing detention region;
a fluxing conforming quanta region equaling the fluxing quantized quanta region and comprising mass volume of the flowing fluxing fluids in the fluxing quantized quanta region;
a fluxing conforming quanta equaling mass volume of the fluxing conforming quanta region and comprising the fluxing flowing fluids mass volume in the fluxing conforming quanta region comprising the PPLLS;
a fluxing boundaries perfection region equaling the fluxing conforming quanta region and equaling the fluxing flowing fluids mass volume in the fluxing conforming quanta region;
a fluxing boundaries perfection equaling mass volume of the fluxing conforming quanta and equaling the fluxing quantized quanta region comprising the PPLLS;
a fluxing flowing mass and energy highest conserving (MEHC) region affecting mass volume boundaries comprising of mass volume energy highest conserving of the fluxing flowing fluids, comprising the fluxing quantized quanta region;
a mass and energy highest conserving (MEHC) equaling mass and energy of the fluxing flowing fluids in the fluxing flowing fluids, mass and energy highest conserving region spawning one or more versions of the MEHC three versions and each of the three comprising the PPLLS;
a sui generis boundaries equaling the fluxing boundaries perfection;
an inductive film layer spawned by the fluxing flowing fluids affecting the fluxing boundaries perfection, the sui generis boundaries interfacing with the Set;
a structure sui generis boundaries perfection comprising inner surfaces of the Set;
a boundaries perfection region coinciding regions comprising the fluxing conforming quanta region and the fluxing boundaries perfection region coinciding with the sui generis boundaries and the structure sui generis boundaries perfection, bounding the fluxing flowing fluids;
a boundaries perfection comprising boundaries perfection region and the coinciding regions and the sui generis boundaries and the structure sui generis boundaries perfection comprising mass volume of the fluxing flowing fluids comprising the PPLLS;
highest elevations affecting the structure sui generis boundaries perfection, fluxing conforming quanta, MEHC, fluxing boundaries perfection region of the fluxing flowing fluids;
FESD inventions embedded in the structure sui generis boundaries perfection affecting means for minimizing mass volume of the fluxing flowing fluids in the fluxing quantized quanta region to thus lower the PPLLS to an optimally, an ultimately, a maximally or an absolutely least sum;
the PPLLS optimally, ultimately, maximally, absolutely least sum effectuating respectively the fluxing flowing fluids an optimally, an ultimately, a maximally least pressures and backpressures in the fluxing quantized quanta region, thereby, yielding respectively an optimally, an ultimately, a maximally, an absolutely longest longevity of the structure sui generis boundaries perfection;
a nonhomogeneous or homogeneous, a nonuniform or a uniform composition and a nonsteady or steady flowing of the fluxing flowing fluids spawning the fluxing conforming quanta region;
a profile least height and a least length at highest elevations affecting the structure sui generis boundaries perfection, fluxing boundaries perfection and fluxing conforming quanta region;
a transition region of the structure sui generis boundaries cross-sections extending from springing points of a rounded lower area to springing points of a rounded upper area;
a cross-sections perimeter of the conforming quanta, sui generis boundaries perfection region embodying parallel horizontal breadths embodying of a cross-section rounded lowest area region widening into breaths of a transition area region and widening of breadths into a rounded upper area region comprising a curvilinear perimeter compact composite cross-sectional area of the structure sui generis boundaries perfection, fluxing boundaries perfection region of the fluxing flowing fluids, comprising First Fluid Element cross-sections associated with the drainage line cross-sections associated with length portions comprising cross-sections of the Second Fluid Element.
high pressures or a uniform homogeneous fluid comprising the fluxing flowing fluids comprising the boundaries perfection entirely round cross-sections;
a First End of the Inlet affecting an entirely round cross-section and a positive connection to a source of inflows of the fluxing flowing fluids which may comprise the drainage line;
a Second End, an Exhaust, of the outlet embodying an entirely round cross-section and a positive connection comprising outflows into the drainage line;
the PPLD band comprising a smooth narrow S form embodying a length of a longest length of the PP lengths that starts with a lowest form of the PPLD band, extends along a lowest surface of the basin and outlet and affects highest infinitesimal increment of the PPLD orthogonal to infinitesimally lowest increment of a cross-section comprising a highest elevation of the outlet lower surface;
a summit embodying the PPLD band an infinitesimally highest increment furthest from the Inlet and a highest elevation cross-sectional area of the outlet comprising means for maintaining submerged the entire undersurface of the End 2 of the Inlet, the First End of the outlet comprising the globose, globose inverse domain, respectively;
a PAP Line and Angle embodying a tangent to the PPLD band without an intersection and also tangent to either an End 2 of the Inlet or a First End of the outlet and including a rotational angle from the gravitational direction to the PAP comprising less than 180 degrees;
a discharge cross-section surface (DCSS) embodying upright plane through the summit of the PPLD band and a highest cross-section of the outlet and a cross-sectional ending of boundaries of the conforming quanta and structure sui generis boundaries perfections provided the fluxing flowing fluids mass volume flow rate through the Exhaust is greater than through the DCSS wherein the conforming quanta and structure sui generis boundaries perfections extend thru the cross-section of the Exhaust, the Second End of the outlet;
Flush Apparatus means for locating anyplace a set, or a network of nozzles, or a nozzle;
means for stopping suction;
means for precluding the Inlet venting gases in the basin;
a sidelong, a sidelong offset, an offset centric, a centric, an anti offset centric, an industrial and an inline respective GC Sets comprising a respective disposition of the undersurface of the End 2 or the First End submerged in the unchanging mass volume retention region of the basin having sub-domains of the globose, globose inverse respective domain;
an anti sidelong offset and an anti sidelong GC Sets comprising a disposition of the First End of the Inlet in respect to the basin;
a globose and a globose cylindrical shapes of the basin comprising GC Sets distinction;
   a PAP Line and Angle magnitude distinguishing an upright, angled near upright, angled and low angled GC Set.

The Flush Apparatus means for locating anyplace a nozzles set, a network of nozzles, or a nozzle yield a design fluids flush system embedded about walls of the sui generis boundaries. The walls made by assembling, welding of molded panels affectively assemble the Flush Apparatus. A tie-in or a tie-ins set is accessibly disposed. The tie-in receives a threaded compression fitting which attaches a supply line of the design fluids to a tie-in apparatus and the Flush Apparatus means for delivering preselected quantities of the design fluids at preselected pressures and flow rates. The means includes check and control valves that prevent a potential fluid backflow and for operating separately or jointly each of the supply lines and delivering the design fluids of one or selectively more than one admixture. The Flush Apparatus means for delivering of the design fluids include joint and individual rinsing, flushing maintenance of the inductive film layer, a nozzle, a set, or a network of nozzles and/or a major nozzle is of spray varieties known in the art. Each nozzle face is flush to the structure sui generis boundaries in predisposed localities about anyplace necessary.

Atomic Elements, fundamental Fluid Elements, Fluid and Advanced Fluid Elements embrace the MEHC versions embracing the genera everything, the fluxing flowing fluids, fluxing conforming quanta and the GC Sets which discloses boundaries perfection sciences; applied sciences disclose by algorithms computing of the conforming quanta, PPLLS, fluxing boundaries perfection and of the fluxing flowing fluids, MEHC and structures of fundamental Fluid Elements and the GC Sets and in general of the Fluid Elements as the GC Sets. The flowing fluids scope includes the Fluid Elements as technologies of the GC Sets; thus, henceforth the Sets are referred to as the GC Sets. Beyond technologies of the GC Sets are sciences of the GC Sets that effectuate nullities in space.

The Industrial Set constituting a Holding Chamber means for detaining the fluxing flowing fluids in the outlet is sustaining the structure sui boundaries perfection into the Exhaust. A conical duel FESD invention, as a part of the Inlet and the outlet, engenders the Inline Set. A respective angle magnitude constituting the PAP Line and Angle differentiates among the upright, the angled near upright, the angled and the low angled Set; an anti sidelong offset, an anti sidelong disposition of the End 1 in respect to the basin embodies the Anti Sidelong Offset, the Anti Sidelong respective Set; wherein, the Second Fluid Element resides in the globose inverse, globose or hybrid domain.

Claims 19 thru 22 define structure parameters, and the Drawings Brief and Detailed Descriptions illustrate, describe, detail and define the First and the Second Fluid Elements respective structure which computing algorithm iterations of fluxing flowing fluids compositions, the MEHC and the PPLLS asymptotical spawning of the fluxing boundaries perfection define to highest resolutions.

The MEHC, PPLLS diversities differentiate among parameters various structures of the GC Sets. Likewise technologies of the PPLLS nurtured energy in each bodily organ from infancy develops the body, improves quality of life and life expectancy which, thus, advances all medical sciences.

PAP Angles quantify the flowing fluids largest rotational components of flows against gravity by the GC Sets, conforming quanta, PPLLS, computing algorithms and quantum accuracies defined. Inside boundaries perfection, energy source work in spinning quantum is only of academic value. In modeling of prototypes of the GC Sets, of fluids viscosities accounts for that spinning wherein modeling the prototypes includes skills in modeling the fluxing flowing fluids, the inductive film layer and viscosities in boundary layers at structure interfaces as is set forth by laboratory testing.

Mass of the MEHC in fluids quanta equals quantum quantized mass. In flows of incompressible fluids, specific gravities of quantum transfers mass of quantal quanta into flowing fluids volume. Energy of mass in the MEHC algorithms iterations comprises conforming quanta PPLLS energy.

The PPLLS of the flowing fluids, conforming quanta effectuates the boundaries perfection of the Fluid Elements; algorithms iteration in computing the PPLLS asymptotically approaches volume of quantum defined the conforming quanta and revealed structure surfaces of the Fluid Elements. The Advanced Processors comprise the sui generis boundaries in compressible fluids wherein the flowing fluids affect least flow pressures and gravitational hydrostatic pressures approach nullity.

The flowing fluids spawn the Advanced Fluid Elements, Fluid Elements and structure sui generis boundaries maximally low or negative backpressure at and into their respective mass energy sink yielding strict compliances with the First, Second Law absolute conformance to the Second Law; that but for the work by Tesla establishes the prior sciences and art as profoundly, deeply flawed.

Minimizing a variable or variables of a mathematical function is known in mathematical science. Applied science minimizes a variable or variables by means of finite element or quantum, which can comprise an electron, computing algorithms attained minimizing of the variable or variables.

The art of computer algorithms modeling of fluid genres and structures construction technologies affects means for modeling of the sui generis and flowing fluids boundaries perfections, spawned by the First and Second Fluid Elements, fundamental Fluid Elements and the inductive film layer boundaries comprising the fluxing flowing fluids, the MEHC and/or QCMEHC respective flows.

The flows yield the quanta least volume, sui generis boundaries defined genres to finite elements exactitudes in highest resolutions, which in resolutions utilization correlate with quantum energy, wherein finite elements computing technologies affect the boundaries perfections of the GC Sets.

Correlations among the Advanced Processors magnetic fields and the Fluid Elements effectuated universal genres disclose universal quantal fluid dynamics evolving of GC genus genera wherein the quantal fluid dynamics affect the sui generis boundaries respective perfection. The PAP Line two tangent lines extend from a globose End 2 or a globose inverse First End, which correlates to epigene surface and a fundamental Second Fluid Element constituting the PPLD band two bands. The magnetosphere, gravitational three directional fields in the Second Fluid Element appears as two directional. Under Solar and cosmic wind pressures and radiations, the magnetic field's two cusps comprise the PPLD band two shortest innermost paths on inner surfaces; two shortest PAP Lines, each from a respective End 2 or First End, each tangent to one of the PPLD bands, in each of the two cusps the top of the troposphere correlate genres of the genus genera. The PAP Lines, the PPLD bands with tangent points dispositions in funnels cross-sections of the cusps, correlates forms equal functions genres of the Earth Advanced Processor magnetosphere magnetic field and Second Fluid Elements comprising the fluxing flowing fluids, sui generis boundaries perfections.

The magnetosphere is innately a benign globose inverse Set, and an energetic Sidelong Set, also. Globose inverse domain Sets are suctions prone; globose domain energetic Sidelong Sets and the flowing fluid angular momentum require volume safety margins as supra, the following indicate. The Earth's magnetic field in transient transformations modulates among globose inverse Set and sidelong Set configurations. In unpredictable chains of forbidden mechanisms, plasma fountains, minuscule outflow can end in a partial or a complete blow-off of the ionosphere, the atmosphere.

The GC Sets, sui generis boundaries and globose conduit quantal fluid energy spawn these genus generic Genres: Genre “a”, the GC Sets, the sui generis boundaries as revolutionary technologies innovations, inventions yielding fluid mass devices; Genre “b”, the paths of passage (PP) lengths least sum, the PPLLS, constituting algorithms computing and a device, in-situ, forcing functions: fluid compositions least quanta and fluid energy demands in retaining of boundaries, by quantum concurrent PP tracings determined the fluid quanta volume and energy demand of the sui generis boundaries; Genre “c”, the PAP Line and Angle, orienting and configuring of a Set disposition of the Inlet, basin, outlet and the FESD inventions; Genre “d”, the-paths-of-passage-of-least energy demand, the PPLD, embracing algorithms computing, quantum energy traced, maximally longest tracings path in the PPLLS; Genres “b” and “d”, both requiring accurate computing technologies.

The Advanced Processors, Fluid Elements and atoms in the genus genera, boundaries perfections correlate and colligate genres, except for the electrons minute mass inability to engender suction. The atoms, the sui generis boundaries and the Advanced Processors, as inorganic, and the human epidermis, as organic mass energy forms, affect—forms equal functions—genus evolving genres.

In the Theory of Everything solutions context, comparative analogies among the Advanced Fluid Elements, flowing fluids, boundaries perfection shown in the atoms, GC Sets is yielding building mechanisms that unify the Universe. Extensions of magnetosphere boundaries and extensions of human epidermis and limbs yield complete complements of embodied genus genres of forms; by the fluxing boundaries perfection, functions comparative analogies holds true irrespectively of all internal forms. In said comparative analogies, which analyze functions crucial issues, the human nervous system relates to the magnetic field lines; most of the cardiovascular system corresponds to the magnetosphere fluid and river systems; the epidermis internal organs engendered functions corresponding to epigene functions. In the Theory of Everything, comparative analogies epigene fluid and fluids, as a renal system, suffer chronic and at times severe discomposing malfunctions, revealed in geology stratigraphic records which chart undisputable evidence of epigene mass and energy light liquids greatly depleted reserves. In said comparisons, the root and causal effects of temperature rises in the magnetosphere bounded light fluids arise from epigene innate and severe malfunctioning—severe “renal system” malfunctioning aggravated by not insignificant quantities of greenhouse gases AGW constituents in the atmosphere. A remediation of renal malfunction is a timely dialysis procedure. The Second Fluid Element, conforming quanta affect a least volume retention and needs the fluxing flowing fluids least mass additional margin for reliable operation. The polar ice caps comprise light fluids fresh water phases crucial margins that cool environment and support fauna and flora. Scientific communities certainly seem to think that such is the case.

Most significantly, continental groundwater levels sullen lowering is drying up the epigene crust, as polar caps are melting while epigene crust ails from 4.5 billion years old irreversible processes that decoupled enormous mass of its pure water. AGW CO2 emissions 500 years duration is not insignificant unavoidable water mass forced additional decoupling; scientific communities focus on climate change is really incorrect only to the extent that the root causal effects reside in sullen dry up of the continents and the plasma fountains light plasmas decoupling from the Earth fluids.

The conforming quanta, MEHC, QCMEHC or QCNDMEHC forced directional changes concede portions of energy by transferring flow energy into stresses and strains energy of distortion to the structure sui generis boundaries. Flows energy surfaces dispositions (FESD) inventions optimize the flow energy, MEHC by minimizing a flow directional change a cause and effect relationship. The GC Sets, globose, spherical shapes are susceptible to improvements by the FESD inventions.

The conforming quanta, FESD inventions minimize least mass and rotations which minimize the PPLLS which in turn, also, minimizes backpressures and pressures of the fluxing flowing fluids, which maximizes longevities of the MEHC, maximizing longevities of the structure sui generis boundaries, in turn;

these comprise such inventions; prior applications detail, illustrate more of the FESD inventions:
a Ridge, a Fin, a Trough, a Bridging Wall, a Nozzle, a summit;
a Crescent, an Annular Valley basin lowest surface pitched downward PPLD FESD ending in a summit and shortened a PPLD band length;
a Partition, a Window, a Three Dimensional Window, a Circumferential Window, a Circumferential Ridge, an oversized outlet, especially versions of Sub-outlets;
a fluids manager, and fluids manager around fluids manager;
a Bridging Wall;
a conical duel FESD;
a globose End 2, a globose inverse First End, a Conical duel FESD;
a version of Flush Apparatus parts and surfaces;
DCSS Sub-outlets, GC modulating cross-sections,
a three-dimensional (TD), a circumferential, an axial or a transverse a Trough, a Ridge; an Inlet a Ridge a Trough; a Trough in a Trough, a Ridge, a Partition with/without a Window(s); a Ridge, a Trough, a Trough in a Trough, a Partition with/without a Window(s), a Troughs-Ridge, a Troughs-Ridge-Partition and a Window(s);
a Circumferential Trough, a Ridge, a Partition, a three-dimensional Window and a Troughs-Ridge and a Troughs-Ridge-Partition and a three-dimensional Window(s);
a Nozzle form, local and highly directional spouts as FESD forms;
a globose End 2, a globose inverse First End, a PPLD counterpart band;
a Bridging Wall with Domed Cavities about an Inlet;
a version of a Fin;
a Trough, a Ridge, a Partition with/without a version of a Window;
a Trough inside a Trough, a Troughs-Ridge, a Troughs-Ridge, a Troughs-Ridge-Partition with or without a version of a Window;
Cavities and dome Cavities;
a rounded, a flared, an Infant Boot, a Fin and an End 2 or a First End;
Dimension(s) 44, (44, 44′), a version of a migration of forms;
a pitched basin a crescent and an annular valley and a rounded form, as a PPLD part;
a version, a DCSS and a GC cross-sectional areas.

All of the outlets embody FESD inventions capacity to pass large fluid quantities, which steadies fluid flows which in a return to optimally least pressures optimally conserves fluids mass energy. In the MEHC flow versions, optimally least pressures comprise flows optimal energy conserving and flow perimeter boundaries optimally least energy of distortion spawning optimal longevities; Sub-outlets cross-sections of the outlet embody means for limiting pressures or avoiding suction.

MEHC Universe organic cell GC Sets include a mouth Inlet and an orifice outlet one cell form, a topic in the priority data revealing the Theory of Everything resolution and MEHC longevities; a least separation between a Set PAP Line and a PPLD band is most preferred, as Set configuration requires a least energy reserves capacity that avoids a flowing fluids progressive clogging failure.

### BRIEF DESCRIPTION OF THE DRAWINGS

Principles of inventions that the specifications document and disclose and the drawings illustrate are not limited to the illustrated examples. Having a Figure of a Fluid Element, one could make modifications and vary figures of the same and not depart from scope of the inventions, disclosed by the inventions. The technologies and principles of the inventions are susceptible to variations.

The disclosure of the Fluid Elements can be considered as an exemplification of the principles of the inventions and is not intended to limit the inventions to the Fluid Elements illustrated, herein. The magnetosphere fluxing boundaries and magnetic lines forcing disconnections, reconnections profusely described and illustrated in the literature, on the Internet need no illustration, herewith.

FIG. 1 of the drawings shows a GC genus schematic and a Second Fluid Element in an elevation view taken generally about a longitudinal plane of symmetry embodying a PAP Line;

FIG. 1A of the drawings shows a globose genus Second Fluid Element schematic in an elevation view taken generally about a longitudinal plane of symmetry embodying a PAP Line;

FIG. 1B of the drawings shows a simple trap schematic of the prior art taken generally in an elevation view about a longitudinal plane of symmetry;

FIG. 2 of the drawings shows a globose sidelong Second Fluid Element invention and FESD inventions in an elevation view generally taken about a longitudinal plane of symmetry embodying a PAP Line;

FIG. 3 of the drawings shows a sectional view taken generally about Section A-A shown in FIG. 2 invention;

FIG. 4 of the drawings shows a globose circumferential sidelong Second Fluid Element invention and a Flush Apparatus invention and an End 2 FESD invention in an elevation view taken generally about a longitudinal plane of symmetry embodying a PAP Line;

FIG. 5 of the drawings shows a cross-sectional view of a Ridge FESD invention taken generally about Section C-C shown in FIG. 4 invention;

FIG. 6 of the drawings shows a cross-sectional view of a Trough FESD invention taken generally about Section C-C shown in FIG. 4 invention;

FIG. 7 of the drawings shows a globose centric Second Fluid Element invention, a Flush Apparatus invention and FESD inventions in an elevation view taken generally about a longitudinal plane of symmetry embodying a PAP Line;

FIG. 8 of the drawings shows a cross-sectional view of a FESD invention of a Bridging Wall taken generally about Section CCC-CCC shown in FIG. 7 invention;

FIG. 9 of the drawings shows a cross-sectional view of a FESD invention of a Bridging Wall taken generally about Section C-C shown in FIG. 7 invention;

FIG. 10 of the drawings shows a cross-sectional view of a FESD invention of a Bridging Wall taken generally about Section CC-CC of FIG. 7 invention;

FIG. 11 of the drawings shows a globose centric Second Fluid Element invention, a Flush Apparatus invention and FESD inventions in an elevation view taken generally about a longitudinal plane of symmetry embodying a PAP Line;

FIG. 12 of the drawings shows a globose cylindrical offset centric Second Fluid Element invention, a Flush Apparatus and FESD inventions in an elevation view taken generally about a longitudinal plane of symmetry embodying a PAP Line;

FIG. 13 of the drawings shows a sectional top view taken generally about Section C-C shown in FIG. 12 invention;

FIG. 14 of the drawings shows a globose cylindrical offset centric Second Fluid Element invention and FESD inventions in an elevation view taken generally about a longitudinal plane of symmetry embodying a PAP Line;

FIG. 15 of the drawings shows a globose inverse cylindrical centric Second Fluid Element invention and FESD inventions in an elevation view taken generally about longitudinal plane of symmetry embodying a PAP Line;

FIG. 16 of the drawings shows a top view of a globose centric inline Second Fluid Element invention shown in FIG. 17 invention;

FIG. 17 of the drawings shows a globose centric inline Second Fluid Element invention and FESD inventions in an elevation view taken generally about a longitudinal plane of symmetry embodying a PAP Line;

FIG. 18 of the drawings shows a Partition FESD invention in an elevation view taken generally about a longitudinal plane of symmetry embodying a PAP Line and orthogonal to a longitudinal elevation view shown in FIG. 17 invention;

FIG. 19 of the drawings shows a globose angled sidelong Second Fluid Element invention, a Flush Apparatus invention and FESD inventions in an elevation view generally taken about a longitudinal plane of symmetry embodying a PAP Line;

FIG. 20 of the drawings shows a globose angled sidelong Second Fluid Element invention, a Flush Apparatus invention and FESD inventions in an elevation view taken generally about a longitudinal plane of symmetry embodying a PAP Line,

FIG. 21 of the drawings shows a globose inverse angled centric Second Fluid Element invention, a Flush Apparatus invention and FESD inventions in an elevation view taken generally about a longitudinal plane of symmetry embodying a PAP Line;

FIG. 22 of the drawings shows a globose inverse angled sidelong Second Fluid Element invention, a Flush Apparatus invention and FESD inventions in an elevation view taken generally about a longitudinal plane of symmetry embodying a PAP Line;

FIG. 23 of the drawings shows a globose inverse low angled sidelong Second Fluid Element invention, a Flush Apparatus and FESD inventions in an elevation view taken generally about a longitudinal plane of symmetry embodying a PAP Line;

FIG. 24 of the drawings shows a globose low angled centric Second Fluid Element invention, a Flush Apparatus invention and FESD inventions in an elevation view taken generally about a longitudinal plane of symmetry embodying a PAP Line;

FIG. 25 of the drawings shows a globose circumferential hybrid dual sidelong Second Fluid Element invention, a Flush Apparatus invention and FESD invention in an elevation view taken generally about a longitudinal plane of symmetry embodying a composite PAP Line embodying two PAP lines at same elevations while embodying curving lines in a horizontal projection;

FIG. 26 of the drawings shows a Partition FESD invention in an elevation view taken generally about Section C-C shown in FIG. 25 invention;

FIG. 27 of the drawings shows a First Fluid Element invention in a cross-sectional view;

FIG. 28 of the drawings shows a circumferential strain genus Second Fluid Element invention in a cross-sectional view taken generally through a circumferential basin outlet;

FIG. 29-31 of the drawings shows separately three versions of Flush Apparatus invention networks, assemblies and parts in three globose centric Second Fluid Elements taken generally in respective longitudinal planes of symmetry; and

FIG. 32 of the drawings shows a globose cylindrical centric industrial Second Fluid Element invention, a Holding chamber invention, a Flush Apparatus invention and FESD inventions in an elevation view taken generally about a longitudinal plane of symmetry embodying a PAP Line.

### DETAILED DESCRIPTION OF THE DRAWINGS OF THE PREFERRED EMBODIMENTS

The inventions are susceptible of embodiments in many different versions. There is shown in the drawings and described in detail numerous specific embodiments with the understanding that the present disclosures are considered as an exemplification of the principles of the inventions and is not intended to the limit disclosures, the inventions or embodiments illustrating the genus genera.

The magnetosphere fluxing boundaries and magnetic lines forcing disconnections, reconnections as profusely described and illustrated—in the literature, on the Internet—need no illustration here.

The GC Sets, conforming embodiments embody Inlet 13 cross-sections much smaller than those of the basin 18A, 18B or 18 and outlet 12 cross-sectional areas which preclude suction and/or to connect to a venting stack or a mechanical device that precludes suction; these attach to a crown of the outlet highest cross-sections proximate the DCSS. Optimally low backpressures of the GC Sets completely matching complete complements engender an optimally short height of Inlet 13, commensurate with mass volume of the flowing fluids.

As it will be understood, each of the GC Sets is positioned to receive fluid from a system which requires a drain. Each of the Sets may be made of plastic, such as PVC plastic; however, each of the Sets may likewise comprise a metal casting or other types of material, as is known in the art.

Inlet 13 is shown in the Figures illustrating the globose domain as comprising first end, End 1 38, a second end, End 2, undersurface 40 and threaded region 188. The threaded region 188 is configured to accept standard size pipe threads; however other types of specialty threads which comprise outer or inner windings are contemplated for use. Additionally, while positive connections are shown, it should be understood the connections may likewise comprise a slip type joint or other connection, such as welded connection, among others, some of which may additionally require gaskets. The outlet is shown in domains as comprising the Second End 384 Exhaust configured to accept standard size pipe welded socket; however, other types of connections, such as those identified above with respect to the Inlet are also contemplate for use.

The Figures are shown to illustrate the globose inverse domain as comprising First End 83, undersurface 40 of the outlet. The Inlet as comprises the End 1 as described for the globose domain; however, the Inlet lower end extends into structure of the basin.

The structure sui generis boundaries 8 in the globose domain comprise inner surfaces of the Inlet, basin and outlet, the Inlet outer surfaces in the basin and undersurface 40. Structure sui generis boundaries 8 in globose inverse domain comprise inner surfaces of the Inlet, basin and outlet and outer surfaces of the outlet in the basin and undersurface 40. In the hybrid domain, structure sui generis boundaries 8 are those described above and associated with respective undersurface 40 of the domain.

The unchanging mass volume detention region extends up to and including the highest infinitesimal increment of the entire undersurface of the End 2 40 of the Inlet or the First End 40 of the outlet submerged in the flowing fluids in the retention with no surface tension and no adhesion; wherein, a changing retention region, included in the fluxing detention region, extends from the highest increment of the undersurface 40 to and includes an elevation of the summit, again, with no surface tension and no adhesion. As is apparent, the fluxing flowing fluid flows from Inlet 13 into the basin wherein the fluxing flowing fluids in the unchanging mass volume retention region of the Inlet are associated with the fluxing flowing fluids in the unchanging mass volume retention region in the basin, which, in turn, are associated with the fluxing flowing fluids in the unchanging mass volume retention region in the outlet. The changing retention region in the fluxing detention region associates the unchanging mass volume retention regions in the Inlet, basin and outlet comprising an additional mass volume of the fluxing flowing fluids to maintain submerged the unchanging mass volume retention region.

In operation, it is necessary to first attach the Inlet to a system supply line associated with the fluxing flowing fluid. For instance, the Set may be used in association with the drain of sink, vanity, shower, to name a few. Where the apparatus is used with the drain of a sink, the Inlet and the outlet must first be attached to the respective portions of the system. As will be used the Inlet is positioned upstream from the outlet. Additionally, the attachment is shown to be a threaded fitting, a welded connection for the Inlet, outlet, respectively; however a multitude of other connections are likewise contemplated for use.

Once fully connected into the system, the Set is ready for use. When the fluid is introduced through the End 1 of the Inlet, the fluid enters into the fluxing detention region and proceeds thru the unchanging mass volume retention regions of the Inlet, basin and outlet. In the basin, outlet a free surface of the fluxing flowing fluids rises to a free surface elevation in the Inlet in a radial flow to the sui generis boundaries and submerges the changing retention region of the fluxing detention region. This three-dimensional, radial flow is advantageous because it is capable of accepting and releasing large flow volumes to advantageously deal with head pressures and backpressures as it levels out their peaks, troughs and rising, falling flow rates to steady the fluxing flowing fluids to acceptable levels. Continued flowing of the fluxing flowing fluids through the Set eventually forces their outflows through the outlet 12 and Exhaust 384.

Once a flow has stopped entering into the Inlet, release of it continues to flow out of outlet 12, until stable equilibrium is reached, and as the summit extends above the unchanging mass volume detention region, once at rest equilibrium is reached, as shown in the Figures, free surface 1 is such that the unchanging mass volume retention region and the changing retention regions remain submerged. The two regions submerged create a physical barrier between the End 2 of the Inlet, the First End of the outlet respective globose, globose inverse domain and a region of outlet 12 above free surface 1 at rest.

Should the Set in situ experience clogging, numerous Sets show removable cleaning member 4 either Plug or Cap which may include Handle 4A. Specifically, as explained above, cleaning member 4 is threaded into the basin comprising a part of the structure sui generis boundaries. By rotating the clean member, the cleaning member can be removed, exposing the structure sui generis boundaries, which can be cleaned out, or even flushed. Cleaning member is rethreaded into its original position and the Set is back in use.

Most Sets are shown further comprising Flush Apparatus 10 comprising a tie-in or ties 10 shown as capped. Placed accessibly, the tie-in of the Flush Apparatus is generally to upper areas of the Inlet or as parts of assemblies of cleaning member 4 or handle 4A. Numerous assemblies of the Flush Apparatus illustrated for specific in situ environment comprise means for configuring anyplace a nozzle, a set or a network of nozzles as exemplified and presented in FIG. 29-31. To attach Flush Apparatus 10 the cap is unscrewed and tie-in line connection 10 threaded in place.

With respect to the following explanation of subsequent embodiments, elements having like function or structures are shown with like reference numerals; the explanation generally is not repeated.

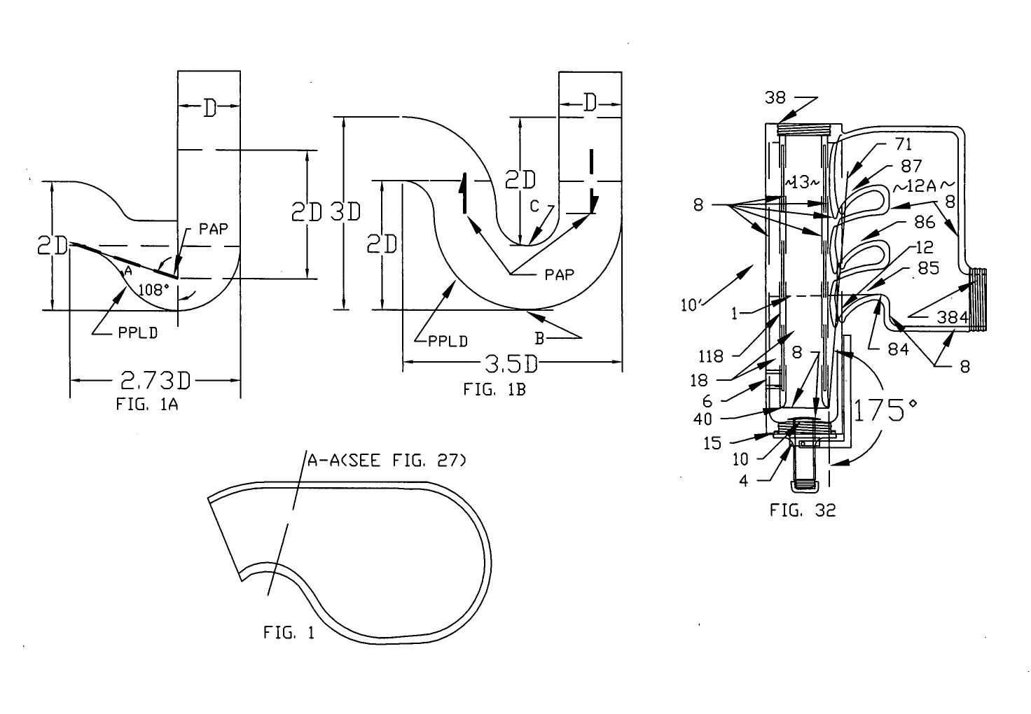

FIG. 1 of the drawings shows a cross-sectional elevation view of a visualized schematic of genus parent taken generally about a longitudinal plane of symmetry that illustrates an elongated outlet that can constitute an orifice form as in one cell organisms which likewise can effectuate an open mouth Inlet. Cross section A-A is innately almost never entirely round but comprises such cross-sections for homogeneous uniform fluids.

FIG. 1A, 1B shows respectively a schematic of the Second Fluid Element, a simple trap known in the prior art, in respective elevation views taken generally in a longitudinal plane of symmetry. Detailed findings of the two are dramatic. In all and any respect, physical genres differences are stunning. The simple trap computed properties show: a) 2.5 times greater fluids mass retention; b) 5 times greater fluids mass interface surface perimeters; c) at least 2.25 times higher operating pressure; d) for one retained fluid quanta turnover at least 2 times energy lift; the outlet forcing large back pressures; e) friction at least 11.25 times greater—b times c; f) at least 5 times more required energy, c times d (and many times more should a GC Set also comprise an outlet FESD described, herewith); g) large angles form directional changes, resulting in 3-90° bends, forming bending moments structural Z-properties, stresses concentration—FIG. 1B noted, Points B and C. A simple trap PPLD is more than twice as long, twice as deep and long enough to cause retention quanta reversing directions that dissipate energy by pulsing outflows latent response disharmony with fluxing fluid inflows; and a discontinuous PAP Line incomplete PAP angle of 180° or more. FIG. 1B, simple trap embodies digestive tract traits while FIG. 1A GC Set embodies conduit traits.

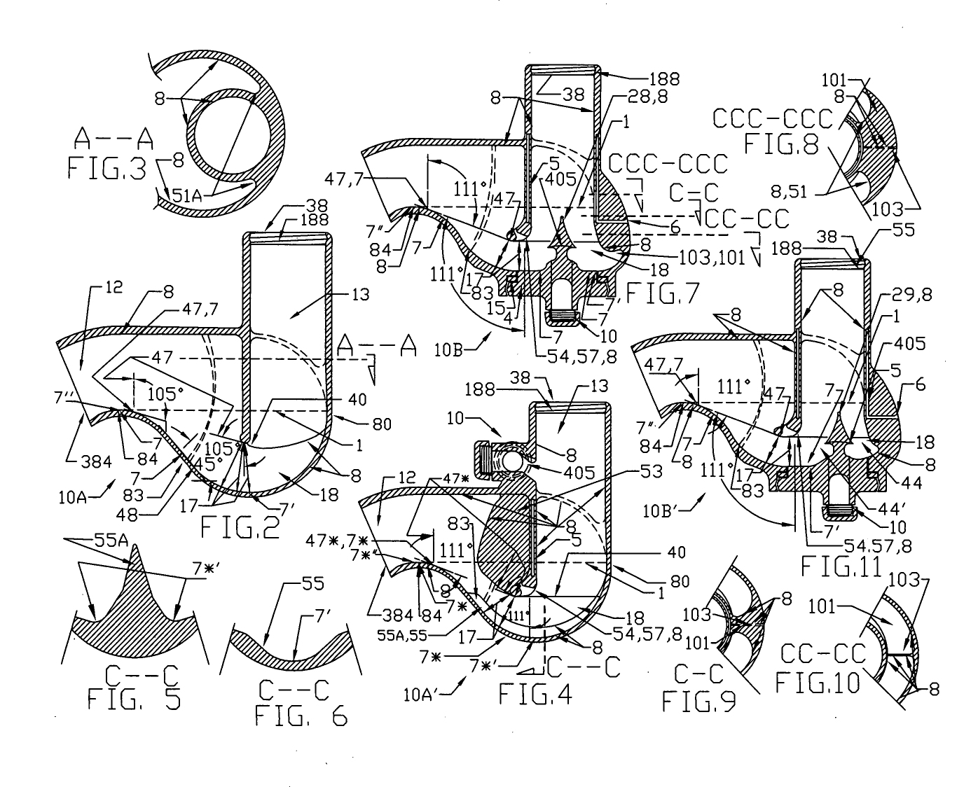

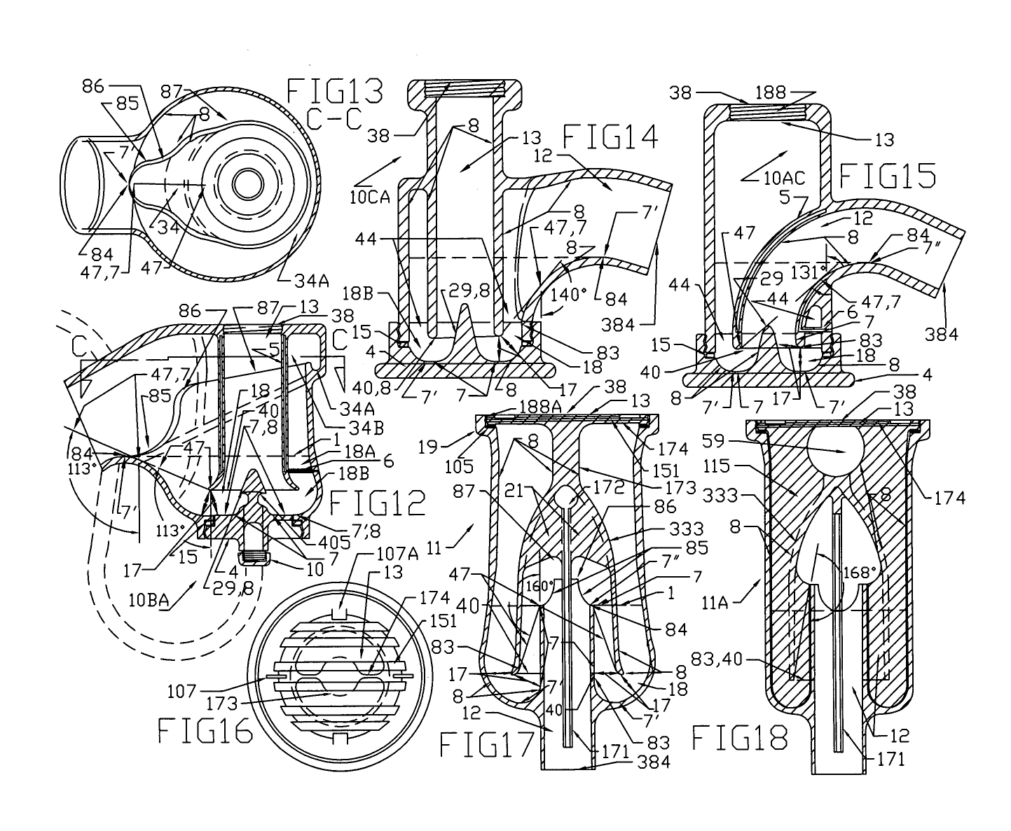

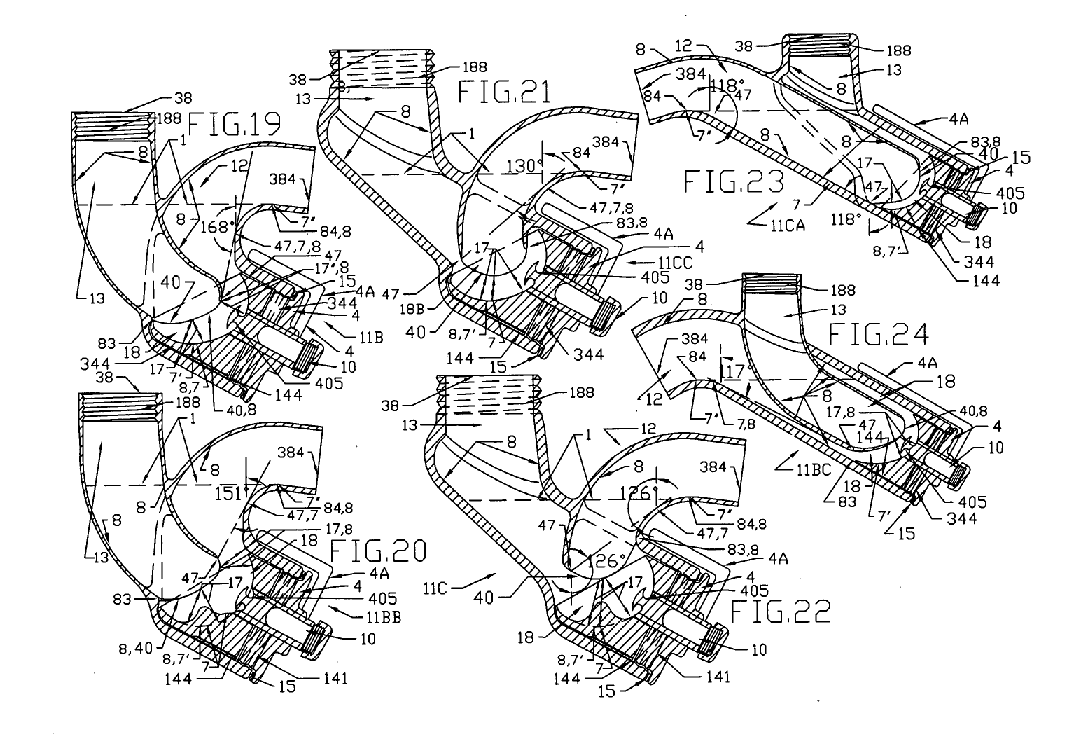

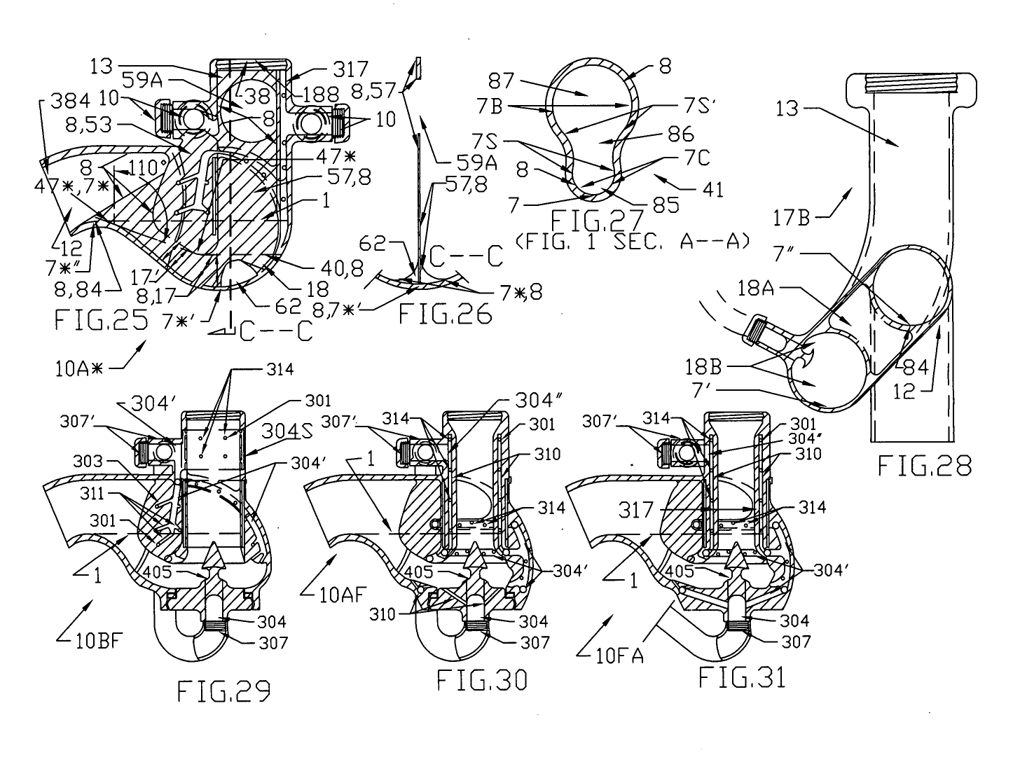

FIG. 3 shows partial sectional view taken generally about Section A-A of the Inlet 13 and upper portion of basin 18 showing Cavities 51A invention of the invention illustrated in FIG. 2.

FIG. 2 show Second Fluid Element Globose Sidelong Set 10A comprising fluid Inlet 13, fluid outlet 12, fluid basin 18 and the fluxing flowing fluids free surface 1 in the Inlet, basin and outlet comprising the boundaries perfections 8, sui generis boundaries perfection 8, quantized quanta region 8. The Set 10A comprises these FESD inventions—fine rounded End 2, convex curvature undersurface 40, Cavities 51, structure sui generis boundaries 8 comprising the fluxing flowing fluids free surfaces at rest 1, summit 7″, DCSS 84 and PPLD band 7 comprising rounded lowest form 7′, First End 83 and summit 7″. The PPLD band is gradually narrowing in width from the rounded lowest form into the summit.

An elevation of an infinitesimal, highest increment of the undersurface 40 comprises the highest elevation of the unchanging mass volume retention region; above that elevation the GC Set affects the fluxing detention region. The changing retention region comprising a portion of the fluxing detention region extends from the highest increment of the undersurface 40 up to and including free surface 1 elevation. The undersurface 40 may comprise other FESD inventions as the following illustrates. The PPLD band affects an infinitesimal and highest increment, furthest from the Inlet, summit 7″. Free surfaces 1 at rest with no surface tension, no adhesion at the summit affect the elevation of the summit. The changing retention region mass comprises safety margins against uncovering of the undersurface 40 by fluxing of the fluxing flowing fluids. The Set embodies with the outlet FESD inventions to effectuate sui generis boundaries 8 maximally least pressures and backpressures of the fluxing flowing fluids. Second End 384 Exhaust has an entirely rounded region configured to accept standard welding socket which may comprise inner or outer diameter welds, as well as other types of connections.

An optimally short height of the Inlet commensurate with the fluxing flowing fluids mass energy retained in the unchanging mass volume retention region and changing retention region has an upper end, the End 1, entirely rounded region 188 configured to accept outer or inner standard size pipe threads, however other types of threads which may comprise outer or inner windings are contemplated for use. Additionally, while positive connections are shown, it should be understood that the connections may likewise comprise a slip type joint or other connection, such as welded connection, among others known in the art, some of which may additionally require gaskets. As with the Inlet, the Second End 384 entirely rounded region may comprise a standard size pipe thread which may be internal or external.

The structure sui generis boundaries cross-sections in the outlet comprise a bounded area of three distinct areas. As described and shown emphasizing differences, the three areas are illustrated in the FIG. 27 cross section which comprises the First Fluid Element.

Smallest cross-sectional area associated with the Inlet comprises a strainer basket or a reservoir, as in a kitchen sink among others, which may detain a portion of the flowing fluid; the DCSS of the outlet configurations comprise appreciable larger cross-sectional areas. That avoids backups of the fluxing flowing fluids quanta, which, in turn yields maximally least pressures and backpressures.

Basin 18 globose form comprises basin blind side having surface inflection point 80. A lower conduit spout comprising a cross-sectional area from the PPLD band, the sui generis boundaries 8 and the undersurface 40 comprises the least separations 17 from undersurface 40 of a rounded End 2 FESD invention having the fluxing flowing fluids cross-sections mass energy centroid of sui generis boundaries 8 to the PPLD band maximal gravitational energy demand that is the least separation that is capable of passing a largest solid particle that passes thru the strainer. Set 10A the PAP Line 47 affects 105° Angle in respect to gravitational direction, comprising a graphical linear approximation of the fluid quanta centroid spawning a path; the Angle is an indication of energy needed to overcome gravity force.

The safety margins comprise a physical barrier between fluid Inlet 13 and fluid outlet 12, which prevents odors in the outlet and basin released thru the fluid into the fluid in the Inlet. Should in situ conditions indicate that clogging may occur, which would be very rare, the Flush Apparatus various assemblies and even a cleaning member, a Cap or a Plug, readily configures into the Set, structure sui generis boundaries in numerous configurations as is illustrated in the Figures.

FIG. 4, GC Set 10A′ shows a globose circumferential sidelong Second Fluid Element invention comprising Ridge 55A FESD invention and globose sidelong Second Fluid Element invention shown in an elevation view generally taken in upright plane of symmetry, the Set comprising sui generis boundaries 8 and these FESD inventions: Infant Boot 54, End 2 undersurface 40; shown in FIG. 5 Ridge 55A, two PPLD bands 7* two lowest rounded forms 7*′ and two PAP Lines 111° angles 47*, one each in two upright hyperbolic surfaces that approach tangency 7″ at DCSS 84, summit 7*” wherein the two 7* PPLD bands individually comprise narrower widths than a single band 7*′ comprising Trough 55 as FIG. 6 shows one PPLD 7*′ basin lowest rounded spot 7′ and single PAP Line 111° angle 47*; Fin 53, and Nozzles 57 and all comprising the separations 17. Hyperbolic surfaces reveal a circumferential strain Set, which distinguishes Set 10A′ with Ridge 55A as a hybrid, wherein the two PAP Lines 47 and two PPLD 7*′ bands appear as one PAP Line and one PPLD band, in side elevation view. Nozzles 57 are symmetrically configured with one on each side of Fin 53. The Set shows dual wall 5 of Inlet 13, passage and orifice 6. Flush Apparatus comprises two tie-ins 10 and major nozzle 405. The tie-ins are shown capped. Each cap is removed, to thread in place supply line 10 attachments.

FIG. 7, GC Set 10B, globose centric Second Fluid Element invention further illustrates the FESD inventions: PPLD band 7 basin lowest annular valley 7′, a basin blind side Bridging Wall 101, sharp edge 103, removable member Plug 4, Flush Apparatus 10, major nozzle 405 and conical form 29 that is optional since the fluxing flawing fluids would spawn such a form, all comprising sui generis boundaries 8, and gasket 15. Likewise illustrated are the dual walls 5, passage orifice 6, to immediately expose an issue, while still functional operationally, by promptly dripping fluid to promptly warn that one of Inlet 13 walls has failed and of immanent complete failure and that the Set should be replaced. The GC Set comprises PAP 47 Line having Angle of 111° and the separations 17.

FIG. 8-10 shows three sections taken thru the Bridging Wall 101, Cavities 51 FESD inventions, associated with the sui generis boundaries 8.

FIG. 11 of the drawings shown globose centric Second Fluid Elements Set 10B′ further illustrates these FESD inventions: Infant Boot End 2 undersurface 40 disposed centrically in the basin 18 and offset centric in respect to Inlet 13, comprising configuration PPLD band 7, pitched basin 18, lowest surface crescent lowest form 7′, Dimensions 44 and sui generis boundaries 8, the PAP 47 Line comprising Angle of 111°, separations 17 comprising means for minimizing the PPLLS.

FIG. 12-13 shows globose cylindrical offset centric Second Fluid Element, GC Set 10BA invention having Inlet 13 disposed centrically offset in fluid basin 18, outlet 12 and these FESD inventions: Circumferential Trough 34A, Trough 34, Ridge 86 87, Partition 87, oversized fluid outlet 12, Tough-Ridge 34A-87, Trough-Ridge-Partition 34A-86-87, Ridge-Partition 86-87, Flared End 2, annular undersurface 40, and PPLD band 7, lowest annular valley 7′; oversized outlet 12 topside of basin 18 comprising First 85, Second 86 and 87 Third Sub-outlet, which preclude suction and minimize the angular momentum of the fluxing flowing fluids; outlet 12 ascends as Trough 34 inside two circumferential Troughs 34A that descend about fluid basin 18; basin 18 about fluid Inlet 13 comprises circumferential Trough 34, Trough-Ridge 34A-87, Trough-Ridge-Partition 34A-86-87 and Trough-Partition 34A-87 which with fluid basin 18 and said outlet 12 affect three dimensional Window 34B and sui generis boundaries 8, all further minimizing the PPLLS. The GC Set comprises PAP 47 Line, Angle of 113° and separations 17.

FIG. 14, Second Fluid Element globose cylindrical offset centric, GC Set 10CA invention shows these FESD inventions: rounded End 2 undersurface 40, outlet 12 ascending spout elliptical cross-sections PPLD band 7 lowest form annular valley 7′, optional conical form 29, Dimensions 44, and cleaning member Cap 4, comprising sui generis boundaries 8, and gasket 15. The Set comprises PAP Line 47, Angle of 140° and the End 2, PPLD separations 17.

FIG. 15 of the drawings show globose inverse cylindrical Set 10AC invention; wherein, if in situ suction is a concern a nipple is threaded thru a threaded hole in crown of outlet 12 as a venting line attachment and a passageway for a mechanical device, to preclude potential suction. Inner surfaces of basin 18, Inlet 13 including undersurface 40, and outer surfaces of the outlet in the basin and Inlet comprise sui generis boundaries 8 and PAP Line 49 comprising Angle of 131°.

FIG. 16-17 GC Set 11 shows globose centric Inline invention hollow, dual conical Partition 333 flared First End 83 of outlet 12, undersurface 40 disposed concentric around upright outlet 12 and disposed centric inside Partition 333 and comprising PPLD band 7 annular valley lowest counterpart form 7′; basin 18 two summits 7″, two PAP Lines, 160° Angles 47 tangents to First End 83, PPLD band 7 annular valley lowest form 7′ in largely hemispherical fluid basin 18, three dimensional DCSS 84, outlet 12 diametrically opposed two First Sub-outlets 85, two Second Sub-outlets 86 and three dimensional Third Sub-outlet 87 and the enumerated above comprise the FESD inventions and sui generis boundaries 8; outlet 12, three dimensional Partition 333, First 85 and Second 86 Sub-outlets comprise flow managers; inside and outside surfaces of three dimensional Partition 333 around inside, outside surface of outlet 12 as three dimensional Partition 12, with Inlet 13 inside surfaces comprising the fluxing flowing fluids three fluid managers. Disposed centrically inside outlet 12 is perforated conduit 171, welded to side plates 21 welded to Partition 333, to make air volume 172 and means for precluding suction as FIG. 18 further explains. Partition 333 and outlet 12 separately migrating in respect to basin 18, Inlet 13 alters dispositions of each wherein Inlet 13, Partition 333 and outlet 12, each can separately rotate in vertical plane to comprise domain of the inline Sets; all of the above comprising sui generis boundaries 8; Inlet 13 End 1 38 and rim 19 are fixed, as is known in the art. Partition 333, post 173 with threaded flange 174 and strainer 151 thread into rim 19; gasket 19 seals the Inlet. Drop-in locking keys 107, 107A lock in the post, flange and strainer. Removing the locking keys, unthreading flange 174 exposes components to cleaning or repair, including the structure sui generis boundaries 8.

FIG. 18 of the drawings shows entirely cylindrical Set 11A invention an elevation view rotated 90° in horizontal plane, showing two dimensional Partition manager 115 that subdivides basin 18 and Inlet 13 into equal halves. The Partition manager upper end comprises Window 59 FESD invention, in addition to the FESD inventions described with FIG. 17 all of which is associated with the sui generis boundaries 8. Rising fluids in one of two halves of fluid basin 18 and fluid Inlet 13, upon rising to Window 59, flows into the other half of fluid Inlet 13, which effectuates Set 11 as comprising of two Sets. Partition manager is supported by basin 12 lowest surfaces and has a close fit separation from threaded flange 174, strainer 151 and gasket 105.

More than one Partition manager 115 is contemplated for use. Additional subdividing of Set 11 into separate cells, compartments, results in First End of the outlet transposing into End 2 of the Inlet. The transposing comprises Set 11A desirable limited partitioning, as the Set is on globose, globose inverse domain boundary. Each added Partition 115 provides the Sidelong Set an added potential to break potential suction, to avoid suction altogether and/or break the fluxing flowing fluids an undesirable momentum. Window 59 can incorporate a mechanical device, if needed to preclude suction by granting air inflow into air volume 172 thru Post 173, comprising a back-up to perforated conduit 171; incorporating the mechanical device into the Post 171 is contemplated.

FIG. 19 shows globose, angled sidelong Second Fluid Element 11B invention comprising highly curved Inlet 13 comprises, counter curved convex, fine rounded End 2, undersurface 40 disposed approximately horizontal in basin 18 sidelong disposition, barely displaced from under End 1 38 of the Inlet and nearly parallel with fluid basin 18 concave lower surface; highly curved outlet 12 from First End 83, nearly parallels undersurface 40 and PAP Line 47 in respect to gravitational direction; PPLD band 7 rounded lowest form 7′, and Filler Member 344, locking key 144, major nozzle 405, Flush Apparatus 10; removable member Plug 4 assembly comprises gasket 15 swivel and handle 4A; structure sui generis boundaries 8 comprise all of the interfaces with the fluxing flowing fluids wherein the End 2 and the Filler Member rounded lowest spot 7′ of PPLD band, comprising counterpart FESD surfaces inventions, structure sui generis boundaries 8. The GC Set comprises PAP 47 Line having Angle of 168° and separations 17.

FIG. 20 shows globose, angled sidelong Second Fluid Element 11BB invention comprises the End 2, counterpart surfaces of the Filler Member 141, PPLD band 7 and PPLD crescent lowest surface 7′, the FESD inventions modified in respect to those shown in FIG. 19 and structure sui generis boundaries 8 otherwise unchanged. The GC Set, PAP 47 Line makes Angle of 151°.

FIG. 21 shows globose inverse angled centric Set 11 CC invention comprising highly curved Inlet 13, counter curved fluid outlet 12 affecting nearly horizontal convex First End undersurface 40 disposed centric in basin 18, offset from under End 1 and nearly paralleling basin 18, concave lower surface formed in Filler Member 344, a PPLD band 7 rounded lowest spot 7′; all of which comprise the FESD inventions, structure sui generis boundaries 8 with Exhaust 384 disposition passed upright position. Basin 18 Filler Member-Plug 344, comprises the FESD invention as is the case of all inner surfaces associates with the structure sui generis boundaries 8. Assembly of Plug 4 comprises: Filler Member 344, Flush Apparatus 10 major nozzle 405, locking key 144, gasket 15, and swivel handle 4A. The GC Set comprises PAP 47 Line having Angle of 130°.

FIG. 22, of the drawings shows globose inverse domain angled sidelong GC Set 11C comprising sidelong disposition of First End 83 of outlet 12 undersurface 40, PPLD band 7, crescent lowest form 7′ of Filler Member 141 comprising the FESD inventions and associated with structure sui generis boundaries 8. The GC Set comprises PAP 47 Line showing Angle of 130°.

FIG. 23 of the drawings shows globose inverse domain low angled Second Fluid Element GC Set 11CA, fluid free surface 1 under End 1 38, highly curved fluid Inlet 13 Inlet an anti-sidelong disposition, low angled outlet 12 convex curving lower portion First End 83, anti-sidelong undersurface 40 disposition that parallels concave lower surface of basin 18, PAP Line 118° angle 47, in respect to gravitational direction, and PPLD band 7 rounded lowest form 7′ and Filler Member Plug 344 and Flush Apparatus 10 major nozzle 405 as the FESD inventions and associated with the sui generis boundaries 8. The End 1 sidelong disposition is contemplate for use. Plug 4 Filler Member 344 further comprises: locking key 144, gasket 15 and swivel handle 4A. The GC Set comprises PAP 47 Line showing Angle of 118°. The PAP Angle of only 118° is good indication that the GC Set is not readily susceptible to clogging.

FIG. 24 of the drawings shows globose domain low angled centric Second Fluid Element, Set 11BC, comprising End 1 38 anti-sidelong disposition in respect to basin 18. The End 1 sidelong disposition is contemplated for use. As with all of the GC Sets all surfaces interfacing with the conforming quanta comprise the sui generis boundaries 8 region interfacing with the fluxing flowing fluids. This GC Set comprises PAP 47 Line having Angle of 118°, only.

FIG. 25-26 illustrate in FIG. 26 shown globose sidelong Set 10A* side elevation view generally taken about longitudinal plane of symmetry and these FESD inventions associated with the sui generis boundaries 8: disposed sidelong End 2 rounded undersurface 40, merged into Partition 57, Fin 53, upright Ridge 317; two PPLD bands 7* lowest rounded forms 7*′ and two PAP Lines 110° angles 47* in two upright hyperbolic surfaces that approach tangency in outlet 12, showing circumferential strain hybrid domain, which distinguishes Set 10* as a hybrid, wherein the two PAP Lines 47* and two PPLD 7*′ bands appear as one PAP Line and one PPLD band in a side elevation view. The fluxing flowing fluids inflowing randomly into one side of the Partition randomly flushes more both sides of Partition 57, PPLD band 7*. When levels of the fluxing flowing fluids reach elevation of Window 59A, outflows would affect equal passing thru both halves of the Set. Window 62 assures that the fluxing flowing fluids flush each of the two PPLD bands 7*. Set 10* likewise includes Ridge 317 and Partition 57 Flush Apparatus parts, four tie-ins 10 and one major nozzle 405. The GC Set comprises PAP 47* Line having Angle of 110°.

FIG. 27 shows three cross-section areas an elevation of First Fluid Element 41 invention, which for illustration purpose enhances differences in the three coinciding areas of the region, the sui generis boundaries 8 and structure 41, which embrace the boundaries perfection, the conforming quanta region. The cross-section 41 comprises three cross-sectional areas boundaries perfection. Lowest, generally not larger than either of the other two comprising cross-sectional area 85. The boundary perfection 8 transitions into the transition region, cross-sectional area 86 and further transitions into largest of the three cross-sectional area 87; that closes the region 8 boundary in optimal rounding of area 85 and 87 by means for comprising complete complements of cross-section 41 areas respective breadths; well narrowed breadths from invert, PPLD band 7, to an elevation, such as 7C, cross-sectional area 85, generally but not always make springing points 7S to transition into cross-sectional area 87 that constitutes springing points 7B. First Fluid Element 41 invention is cross-sectional areas boundaries distinctive signature, showing Fluid Elements genus DNA associated with nonuniform nonhomogeneous fluids apparent in the Second Fluid Elements and Fluid Elements, GC Sets and FESD inventions shown by cross-sectional areas and perimeter genres. Especially in the DCSS and anywhere, the perimeter genres of embodiment 41 spawn the fluxing flowing fluids low, least or restricted backpressures that steady flow pressures. FIG. 1, Section A-A, likewise, reveals adoptability of structure 41 to conform comply with steady or nonsteady, nonuniform or nonhomogeneous, or homogeneous and uniform fluids.

FIG. 28 shows circumferential strain Set 17B as an example revealing parent genres of that strain.

FIG. 29-31 shows Flush Apparatus assemblies in the GC Sets 10BF, 10AF, and 10FA, Second Fluid Elements which are larger than those in FIGS. 4, 7, 11, 12 and 19-25 to rinse, flush clean and maintain the structure sui generis boundaries 8 the boundaries perfection region and serve only as examples of Flush Apparatus associated with tie-in or tie-ins 10, major nozzle 405, assembled in Caps 4 and Plugs 4 shown assemblies, adopted to GC Sets, comprising these parts and elements: Sub-nozzles 301, sub-passageways 303, major nozzles 405, major passageways 304 304′ 304″ 304S, passageways 310 and respective branches set 307′ of tie-ins 10, set of sub-passageways branches 311, and sub-nozzles set 314 are available parts selectively pre-assembled. Flush Apparatus parts numerous assemblies inside walls of the GC Sets are simplified by molded fabrications, wherein the tie-in or the set of tie-ins of the GC Set are outstanding and accessible parts on structure engendering the Flush Apparatus.

FIG. 32 shows an elevation view generally taken about a longitudinal plane of symmetry having PAP Line 71, illustrating globose cylindrical centric industrial Set 10′ suitable in systems having low to very high hydrostatic pressures. Set 10′ constitutes Inlet 13, basin 18, and outlet 12 which comprising Holding12A Chamber detains huge volume of the fluxing flowing fluids. End 1 38 can comprise a high pressure fluid universal joint whose angle settings can be oriented and fixed, in orientation and in respect to gravitational direction. Set 10′ affects the sui generis boundaries 8 into Exhaust 384 showing End 2 undersurface 40, outlet 12 Sub-outlet: First 85, Second 86 and Third 87, and summit DCSS 84, Holding Chamber 12A. A detention of the fluxing flowing fluids in outlet 12 and Holding Chamber 12A unifies the fluxing flowing fluids detained quanta in Set 10′. Thus, rises in fluids free surface level further subdues high pressure fluids oscillation dynamics to steady backpressures and flowing pressures, including outflows thru Exhaust 384.

Holding Chamber 12A readily accepts—a fluid inflow only—check valve or a venting line that prevents a possibility of in situ suction preferably at highest elevations. Second End, Exhaust 384 is shown as comprising an upright disposition; a horizontal disposition is contemplated for use, including the Holding Chamber to encircle Set 10′ assembly. Cleaning member, Plug 4 and swivel handle 4A assembly has Flush Apparatus 10, major nozzle 405 and brass washer 15.

1: A mass energy balancing of balancing everything in bounding sources and sinks of mass and energy is paths-of-passage (PP) of quantum in and from sources into and in sinks of mass energy having quantal mass and quantum PP lengths, spawning the PP lengths least sum (PPLLS) that is cosmological nullity; a mass energy highest conserving (MEHC) of flowing fluids affirms all of cosmological nullities of the nullity and ultimate longevities of conforming quanta and balancing everything to fluxing dispositions of a boundaries perfection; environment energy superimposed dynamics (EESD) unbalance the boundaries perfection of balancing everything; the sources and sinks also affect the ultimate longevities of the flowing fluids, conforming quanta and boundaries perfection, the PPLLS and MEHC of Fluid Elements, constituting genus of everything, genera of everything, the boundaries perfection of Advanced Fluid Elements, Advanced Processors and the Earth's gravitational and magnetic field, the Advanced Processor; all of it constitutes science of Fluid Elements ions, isotopes (FEII), associating with principles, methodologies, innovations and inventions (PMII) cosmological (FEIIPMII), global PMII technologies which engender chains of the ultimate longevities that effectuate balancing everything of everything, especially structure of sui generis boundaries that interface with the boundaries perfection of the flowing fluids; all of it is spawning the PPLLS, conforming quanta and MEHC and/or QCMEHC and QCNDMEHC, the flowing fluids' means for balancing the EESD unbalances; all of those are the PMII technologies of cosmological gravitational dynamics to combat the EESD that imperil Earth's viability; PMII, PPLLS, boundaries perfection, MEHC technologies spawn opposition to the EESD and to energy shortage and groundwater depletion; the FEIIPMII, PMII, Fluid Elements, sui generis boundaries constituting PPLLS clustering technologies in energy devices spawns ultimately least or negative backpressures with maximally direct energy flowing from energy sources to or into energy sinks.

2. The cosmological gravitational dynamics and the EESD of claim 1 wherein atomic elements, plasmas and the Universe cosmological nullities engender the EESD streaming mass continuums and eternally fluxing plasmas, balance the boundaries perfection of everything, the genera of everything, and spawn the cosmological gravitational dynamics; the cosmological nullities yield the genera of everything, the Advanced Fluid Elements, which resolves the Theory of Gravitational Dynamics; all of it resolves the Theory of Uniformity; wherein, solutions to the two Theories, the EESD, the Advanced Fluid Elements and cosmological nullity engendering the boundaries perfection solve the Theory of Everything; that solves The Three Theories; wherein, universally stunning uniformity is omnipresent demands for light fluids energy; from infinity of space to infinitesimal detail, discloses the fundamental Fluid Elements, the solutions to the Three Theories and the civilizations survival highly limited principal options solitarily course of action; shrinking water sources and regulating CO₂ emission cuts cannot effectively conserve water; the sui generis boundaries in ubiquitous devices timely maximal benefit avoid a doomsday scenario; the flowing fluids, conforming quanta, PPLLS, boundaries perfection maximal conformances to the Second, First Law embody the boundaries perfection, devices that yield maximal longevities.

3: The cosmological gravitational dynamics and the EESD of claim 1 wherein
the flowing fluids spawn the Advanced Fluid Elements, Fluid Elements and structure sui generis boundaries maximally low or negative backpressure at and into their respective mass energy sink yielding strict compliances with the First, Second Law absolute conformance to the Second Law.

4: The mass energy balancing of balancing everything of claim 1, wherein
the flowing fluids, PP, PPLLS and conforming quanta in omnidirectional environment comprise low to negative backpressures embodying the PPLLS, MEHC versions to anywhere gravitational sink; since the First, Second Law is universal, mass energy genres of the PP, PPLLS is universal; thus, genres of parameters correlate the Advanced Processors to the fundamental Fluid Elements.

5: The conforming quanta, PPLLS, boundaries perfection according to claim 2 the flowing fluids of mass energy sources and outflow fluids of mass energy sinks yield the PP in the flowing fluids fluxing environment maximal longevities of the conforming quanta that constitute the boundaries perfection, PPLLS and MEHC technologies of energy by and/or against gravity; a conforming to the PPLLS, MEHC, boundaries perfection and conforming quanta and to a globose conduit (GC) yields structure parameters comprising the sui generis boundaries of the GC Sets, Fluid Elements comprising the genus generic genres and genera of everything; all of celestial bodies disclose it.

6: The sui generis boundaries according to claim 1 wherein
the PPLLS of the flowing fluids, conforming quanta effectuates the boundaries perfection of the Fluid Elements; algorithms iteration in computing the PPLLS asymptotically approaches volume of quantum defined the conforming quanta and revealed structure surfaces of the Fluid Elements.

7: The mass energy balancing of balancing everything according to claim 1 wherein the flowing fluids, PPLLS, conforming quanta spawn the structure of the sui generis boundaries.

8: An absolute device, a region has flowing mass and energy of quantum or electron subdividing flowing mass energy of quanta which takes a path least length of path lengths that make quantum or electrons a paths-of-passage lengths sum (PPLS), lengths of quantum or electron energy paths, which constitute mass and energy of the subdivided quanta. Minimizing the PPLS to a least sum (PPLLS) spawns the boundaries perfection of conforming quanta, the region and the least energy demanded by the path lengths; the conforming quanta spawned an optimal to absolute sum of the PPLLS yields an optimal to absolute energy, respective least energy; the absolute device, region, conforming quanta, boundaries perfection affects cosmologically least energy of absolute energy.

9: The absolute device according to claim 8 wherein
mass and energy essences of the boundaries perfection region, by constituting the PPLLS, spawn a cosmological absolute conductivity region of an alternating, a direct current, or an energy flow; wherein an electron mass is indivisible, the cosmologically absolute conductivity is unmatchable.

10: The cosmological FEIIPMII, global PMII technologies according to claim 1 wherein
a structure of the PMII, PPLLS technologies yields perfections of the electrons, atoms and Fluid Elements and their clustering into the MEHC of the Advanced Processors, as in magnetospheres; the FESD inventions overlying the boundaries perfection spawn the PPLLS absolutely least sum with a PPLD band an absolutely least length and the conforming quanta an absolutely least mass.

11: The cosmologic balancing of everything according to claim 1 wherein
the FEIIPMII, PMII technologies spawn atmospheric mass through precipitation constituting the conforming quanta, MEHC, boundaries perfection and PPLLS technologies of the flowing fluids, to engender means for in parts transferring thermal energy of that mass into epigene crustal mass.

12: The cosmological FEIIPMII, global PMII technologies according claim 1 wherein
the PMII technologies boost the gravitational and magnetic fields in their boundaries perfection. the technologies empower the gravitational and magnetic fields with their boundaries perfection.

13: The PPLLS, boundaries perfection, MEHC technologies according to claim 1 wherein
the technologies maximize mass and energy conductivities toward the Earth's gravitational sink.

14: The PPLLS, boundaries perfection, MEHC technologies according to claim 4 wherein
the technologies maximizes an electron path, electrons' paths and or flowing fluids mass energy.

15: The cosmological FEIIPMII, global PMII technologies according to claim 1 wherein
the technologies spawn energy means for transposing of the fluids in the atmosphere into epigene groundwater wherein cumulative effects slows momentum of the EESD accelerating momentum.

16: The cosmological FEIIPMII, global PMII technologies according to claim 1 wherein
the technologies yield energy transfers to avoid the Sun's means for charging the detention basin.

17: The mass energy balancing of balancing everything according to claim 1 wherein the conforming quanta, PPLLS technologies and absolute conformances to the Second Law compete absolutely in the light fluids cosmological mass energy cycling demands that balance everything.

18: The gravitational filed, magnetic field according to claim 17 wherein
retaining vapor till it liquefies is only means for keeping the light fluids in the gravitational sink.

19: A Second Fluid Element, a Set, a trap apparatus, associated with a drainage line comprising:
an Inlet capable of accepting in flowing, releasing outflow of fluxing flowing fluids, to maintain submerged an unchanging mass volume retention region in the Inlet;
a basin associated with the Inlet capable of accepting in flowing, releasing outflow of the fluxing flowing fluids, to maintain submerged a unchanging mass volume retention region in the basin;
an outlet associated with the basin and capable of accepting in flowing, releasing outflow of the fluxing flowing fluids, to maintain submerged an unchanging mass volume retention region in the outlet;
an unchanging mass volume retention region comprising of unchanging mass volume retention regions comprising the fluxing flowing fluids least mass volume, a retention, retained in the Inlet, basin and outlet;
a fluxing detention region capable of detaining a fluxing mass volume, a detention, comprising the fluxing flowing fluids respective mass volume detained in the Inlet, basin, outlet;
means for maintaining an entire undersurfaces of an End 2 of the Inlet or a First End of the outlet submerged in the fluxing flowing fluids retained in the unchanging mass volume retention region of the basin;
an undersurface of the End 2 of the Inlet or the First End of the outlet and in a curving upright surface plane of symmetry effectuated a PAP Line, or said End 2 or said First End submerged in the unchanging mass volume retention region of the basin classifying a hybrid, a globose, a globose inverse structure respective domain of the sui generis boundaries perfection, the Second Fluid Element;
a fluxing quantized quanta region equaling the unchanging mass volume retention and the fluxing detention regions;
the fluxing quantized quanta region subdivided into mass energy quantum constituting a paths-of-passage (PP) lengths least sum (PPLLS) of the PP concurrent mass energy paths effectuating a passage of the fluxing flowing fluids detained mass and energy in the fluxing detention region;
a fluxing conforming quanta region equaling the fluxing quantized quanta region and comprising mass volume of the flowing fluxing fluids in the fluxing quantized quanta region;
a fluxing conforming quanta equaling mass volume of the fluxing conforming quanta region and comprising the fluxing flowing fluids mass volume in the fluxing conforming quanta region comprising the PPLLS;
a fluxing boundaries perfection region equaling the fluxing conforming quanta region and equaling the fluxing flowing fluids mass volume in the fluxing conforming quanta region;
a fluxing boundaries perfection equaling mass volume of the fluxing conforming quanta and equaling the fluxing quantized quanta region comprising the PPLLS;
a fluxing flowing mass and energy highest conserving (MEHC) region affecting mass volume boundaries comprising of mass volume energy highest conserving of the fluxing flowing fluids comprising the fluxing quantized quanta region;
a mass and energy highest conserving (MEHC) equaling mass and energy of the fluxing flowing fluids in the fluxing flowing fluids, mass and energy highest conserving region spawning one or more versions of the MEHC three versions and each of the three comprising the PPLLS;
a sui generis boundaries equaling the fluxing boundaries perfection;
an inductive film layer spawned by the fluxing flowing fluids affecting the fluxing boundaries perfection, the sui generis boundaries interfacing with the Set;
a structure sui generis boundaries perfection comprising inner surfaces of the Set;
a boundaries perfection region coinciding regions comprising the fluxing conforming quanta region and the fluxing boundaries perfection region coinciding with the sui generis boundaries and the structure sui generis boundaries perfection, bounding the fluxing flowing fluids;
a boundaries perfection comprising boundaries perfection region and the coinciding regions and the sui generis boundaries and the structure sui generis boundaries perfection comprising mass volume of the fluxing flowing fluids comprising the PPLLS;
highest elevations affecting the structure sui generis boundaries perfection, fluxing conforming quanta, MEHC, fluxing boundaries perfection region of the fluxing flowing fluids;
FESD inventions embedded in the structure sui generis boundaries perfection affecting means for minimizing mass volume of the fluxing flowing fluids in the fluxing quantized quanta region to thus lower the PPLLS to an optimally, an ultimately, a maximally or an absolutely least sum;
the PPLLS optimally, ultimately, maximally, absolutely least sum effectuating respectively the fluxing flowing fluids an optimally, an ultimately, a maximally least pressures and backpressures in the fluxing quantized quanta region, thereby, yielding respectively an optimally, an ultimately, a maximally, an absolutely longest longevity of the structure sui generis boundaries perfection;
a cross-sections perimeter of the conforming quanta, sui generis boundaries perfection region embodying parallel horizontal breadths embodying of a cross-section rounded lowest area region widening into breaths of a transition area region and widening of breadths into a rounded upper area region comprising a curvilinear perimeter compact composite cross-sectional area of the structure sui generis boundaries perfection, fluxing boundaries perfection region of the fluxing flowing fluids, comprising First Fluid Element cross-sections associated with the drainage line cross-sections and associated with length portions comprising cross-sections of the Second Fluid Element.

20: The Second Fluid Elements according to claim 19 wherein
the Industrial Set constituting a Holding Chamber means for detaining the fluxing flowing fluids in the outlet is sustaining the structure sui boundaries perfection into the Exhaust; a conical duel FESD invention, as a part of the Inlet and the outlet, engenders the Inline Set; a respective angle magnitude constituting the PAP Line and Angle differentiates among the upright, the angled near upright, the angled and the low angled Set; an anti sidelong offset, an anti sidelong disposition of the End 1 in respect to the basin embodies the Anti Sidelong Offset, the Anti Sidelong respective Set; wherein, the Second Fluid Element resides in the globose inverse, globose or hybrid domain.

21: The Second Fluid Elements according to claim 26 wherein
the FESD inventions overlying the boundaries perfection spawn the PPLLS absolutely least sum.

22: The Second Fluid Element, the Fluid Element, according to of claim 19 comprising
the Flush Apparatus means for locating anyplace a nozzles set, a network of nozzles, or a nozzle yield a design fluids flush system embedded about walls of the sui generis boundaries; the walls made by assembling, welding of molded panels affectively assemble the Flush Apparatus; a tie-in or a tie-ins set is accessibly disposed; the tie-in receives a threaded compression fitting which attaches a supply line of the design fluids to a tie-in apparatus and the Flush Apparatus means for delivering preselected quantities of the design fluids at preselected pressures and flow rates; the means includes check and control valves that prevent a potential fluid backflow and for operating separately or jointly each of the supply lines and delivering the design fluids of one or selectively more than one admixture; the Flush Apparatus means for delivering of the design fluids include joint and individual rinsing, flushing maintenance of the inductive film layer, a nozzle, a set, or a network of nozzles and/or a major nozzle is of spray varieties known in the art; each nozzle face is flush to the structure sui generis boundaries in predisposed localities about anyplace necessary.

23: The mass energy balancing of balancing everything of claim 1, wherein
an eternal nullity PPLLS, the PPLLS nullity, boundaries perfection, genus generic genres spawn genera that spawn the PP of quantum mass energy to precise nullities of the PPLLS, to effectuate the boundaries perfection and eternal longevities; the Universe, nonradioactive atomic elements disclose the boundaries perfection and inside each the precise nullities, PPLLS which spawns the conforming quanta, boundaries perfection and eternal longevities which colligate the conforming quanta, MEHC and PPLLS to the eternal longevities, PPLLS affecting the boundaries perfection.

24: The absolute device as a technology unit makes path lengths of the path length in series and/or in parallel increments that comprise a clustering of the absolute device wherein the absolute device, the region, the conforming quanta and the clustering of boundaries enlarges in steps; the absolute device, in increments of absolute device, incorporates into an electrical conduit, circuit boards, or an energy device; the absolute device with cosmologically least energy in increments amends the conforming quanta, region profound flaws in a monitor, a screen, a phone and any energy device.
